(19) United States
(12) Patent Application Publication
(10) Pub. No.: US 2014/0172494 A1
(43) Pub. Date: Jun. 19, 2014

(54) MULTI-BASE INVENTORY DEPLOYMENT COMPUTATION DEVICE

(71) Applicants: Junko Hosoda, Tokyo (JP); Kenichi Funaki, Tokyo (JP); Atsushi Shimoda, Tokyo (JP)

(72) Inventors: Junko Hosoda, Tokyo (JP); Kenichi Funaki, Tokyo (JP); Atsushi Shimoda, Tokyo (JP)

(21) Appl. No.: 14/237,181

(22) PCT Filed: May 14, 2012
(86) PCT No.: PCT/JP2012/062334

§ 371 Date: Feb. 5, 2014

(30) Foreign Application Priority Data
Aug. 5, 2011 (JP) 2011-172122

(51) Int. Cl. G06Q 10/06

(52) U.S. Cl. CPC G06Q 10/06315
USPC 705/7.25

(57) ABSTRACT

The invention displays multiple inventory period combinations, as multiple multi-base inventory deployment proposals having assessed values for items such as cash flow and inventory value, each of said assessed values being within a range entered by an inventory deployment decision-maker. For each product included in request information, the invention finds a minimum period (the total lead time from when a given item leaves the applicable warehouse until the item reaches the base that sells the applicable product) and a maximum period (the total lead time needed for all component parts configuring the item to reach the warehouse, added to the minimum period), for each item configuring said product and each warehouse base. The invention computes product-specific inventory period combination information for each warehouse base, and creates inventory period combination information by combining said product-specific inventory period combination information for each product type. The invention performs an inventory management calculation for the inventory period combination information, computes the value of an assessment index, and compares said value to the maximum value thereof. The invention selects an inventory period combination having an assessment index value within a permitted range, as a candidate display proposal. For the candidate display proposal, the invention computes a display evaluation value for each display proposal evaluation item by multiplying a display evaluation coefficient by an inventory value.

### TECHNICAL FIELD

The present invention relates to a multi-base inventory deployment computation device.

### BACKGROUND ART

As a background art in the technical field, there is Japanese Patent Application Laid-Open No. 2003-203110 (Patent Document 1). Patent Document 1 describes “a simulation of a distribution network is carried out using a small amount of data in a simplified manner to be able to evaluate the amount of inventories and carrying distribution”. (Refer to Abstract)

### PRIOR ART DOCUMENT

### Patent Document

Patent Document 1: Japanese Patent Application Laid-Open No. 2003-203110

### SUMMARY OF THE INVENTION

### Problem to be Solved by the Invention

Patent Document 1 describes a structure of a distribution network evaluation system. However, plural inventory deployment proposals to avoid out-of-stock to demand fluctuations cannot be compared to each other in the distribution network evaluation system of Patent Document 1.

In general, there are plural possible inventory deployment proposals to supply products or parts to avoid out-of-stock to demand fluctuations in a distribution network composed of plural bases such as sales bases, manufacturing bases, and procurement bases. The plural proposals are the same in terms of avoiding out-of-stock, but are different in terms of the inventory quantity held in each base. Thus, various losses occur in each inventory proposal. In particular, if the inventory quantity held in each base differs in a global distribution network, potential risks (for example, exchange rate fluctuations, inflation, deterioration in security, delay of transportation means, and the like) differ. Therefore, it is important to determine the inventory quantity held in each base in consideration of these potential risks.

Accordingly, the present invention provides means for computing plural inventory deployment proposals with different inventory places and quantities under advantageous conditions of evaluation values of inventory deployment. For example, plural inventory deployment proposals in which inventories are deployed in as different countries and regions as possible under the condition where an out-of-stock ratio to demand fluctuations is within an allowable range can be generated for distribution networks covering all over the world.

### Means for Solving the Problem

In order to solve the above-described problems, for example, the invention employs configurations described in Claims.

The present application includes plural means to solve the above-described problems. The following is one example thereof.

Provided is a multi-base inventory deployment computation device that searches for all multi-base inventory deployment proposals in each of which the value of an evaluation index is within an allowable range relative to the best value in each base on a distribution network to present results in accordance with display proposal determination items, the device including: a memory unit that stores: evaluation condition information including the evaluation index and the allowable range; display proposal determination item information used to quantitatively evaluate the difference between inventory deployment proposals in each of which the value of the evaluation index is within the allowable range; display determination coefficient information defining a coefficient for each display proposal determination item; demand information including sales plans of products; product configuration information representing configurations of items configuring the products; transportation information including information of transportation routes between the bases and transportation lead times; production information including lead times of the bases where each item is supplied and produced; parts purchase unit price information; manufacturing cost information including the cost incurring in manufacturing; and sales price information including the sales prices of the products; a multi-base inventory deployment search unit that obtains a maximum period by adding the total lead time from the time each item is shipped from a warehouse to the time the item arrives at a base where the product is sold to a minimum period and by adding the total lead time until all child products configuring the item arrive at the warehouse to a minimum period for each product included in the demand information, for each item configuring the product, and each warehouse base to compute product-specific inventory period combination information at each warehouse base, and combines the pieces of product-specific inventory period combination information to each other according to each product type to create inventory period combination information; a multi-base inventory deployment proposal comparison unit that computes the value of the evaluation index of the evaluation condition information by performing an inventory management computation for the created inventory period combination information, compares the value with the maximum value of the evaluation index to determine an inventory period combination having the value of the evaluation index satisfying the allowable range as a candidate display proposal, and computes a display determination value by multiplying a display determination coefficient by an inventory value according to each display proposal determination item for the candidate display proposal; and a display unit that displays plural inventory period combinations selected by the multi-base inventory deployment proposal comparison unit.

### Advantageous Effect of the Invention

According to the present invention, plural inventory deployment proposals with the same evaluation value and with different inventory places and quantities can be computed. An inventory deployment decision-maker selects an inventory deployment proposal with a low potential risk to be able to carry out stable production activities in consideration of potential risks such as exchange rate fluctuations, inflation, deterioration in security, and delay of transportation means in each region.

### BRIEF DESCRIPTION OF THE DRAWINGS

FIG. 1 shows an example of a configuration diagram of a multi-base inventory deployment computation device.

FIG. 2 shows an example of a hardware configuration of the multi-base inventory deployment computation device.

FIG. 3 shows an example of a multi-base inventory deployment computation processing flow.

FIG. 4 shows an example of base information.

FIG. 5 shows an example of product configuration information.

FIG. 6 shows an example of production information.

FIG. 7 shows an example of transportation information.

FIG. 8 shows an example of sales price information.

FIG. 9 shows an example of purchase unit price information.

FIG. 10 shows an example of manufacturing cost information.

FIG. 11 shows an example of demand information.

FIG. 12 shows an example of a multi-base inventory deployment proposal comparison condition setting screen.

FIG. 13 shows an example of an inventory deployment display proposal determination item setting screen.

FIG. 14 shows an example of a multi-base inventory deployment proposal display determination coefficient setting screen.

FIG. 15 shows an example of an inventory deployment generation processing flow.

FIG. 16 shows an example of a product-specific inventory period combination generation processing flow.

FIG. 17 shows an example of product-specific inventory period information.

FIG. 18 shows an example of product-specific inventory period combination information.

FIG. 19 shows an example of inventory period combination information.

FIG. 20 shows an example of candidate display proposal information.

FIG. 21 shows an example of inventory value information.

FIG. 22 shows an example of a display proposal determination value computation processing flow.

FIG. 23 shows an example of a display proposal determination item-specific determination value computation processing flow.

FIG. 24 shows inventory value information after being aggregated with a base of inventory period combination No. 758.

FIG. 25 shows a determination value computation result of inventory period combination No. 758.

FIG. 26 shows an example of a result display screen.

FIG. 27 shows an example of a result display screen after selecting inventory combinations by an inventory deployment decision-maker.

FIG. 28 shows an example of an inventory deployment screen.

FIG. 29 shows an example of an inventory deployment display proposal determination item setting screen of a second embodiment.

FIG. 30 shows an example of a multi-base inventory deployment proposal display determination coefficient setting screen of the second embodiment.

FIG. 31 shows an example of a result display screen of the second embodiment.

FIG. 32 shows an example of an inventory deployment display proposal determination item setting screen of a third embodiment.

FIG. 33 shows an example of a multi-base inventory deployment proposal display determination coefficient setting screen of the third embodiment.

FIG. 34 shows an example of a multi-base inventory deployment computation processing flow of a fourth embodiment.

FIG. 35 shows an example of a multi-base inventory deployment proposal comparison condition setting screen of the fourth embodiment.

FIG. 36 shows an example of selecting inventory combinations of the fourth embodiment.

FIG. 37 shows an example of an inventory deployment screen of the fourth embodiment.

FIG. 38 is a diagram for showing a model image of a distribution network related to products.

### BEST MODE FOR CARRYING OUT THE INVENTION

Hereinafter, embodiments will be described using the drawings.

### First Embodiment

Using cash flow as an evaluation index of inventory deployment in the embodiment, an inventory deployment proposal within an allowable range relative to the best value of the cash flow is searched for. For the all inventory deployment proposals in each of which the cash flow is within an allowable range, results selected using regional information of a base that is a display proposal determination item are displayed.

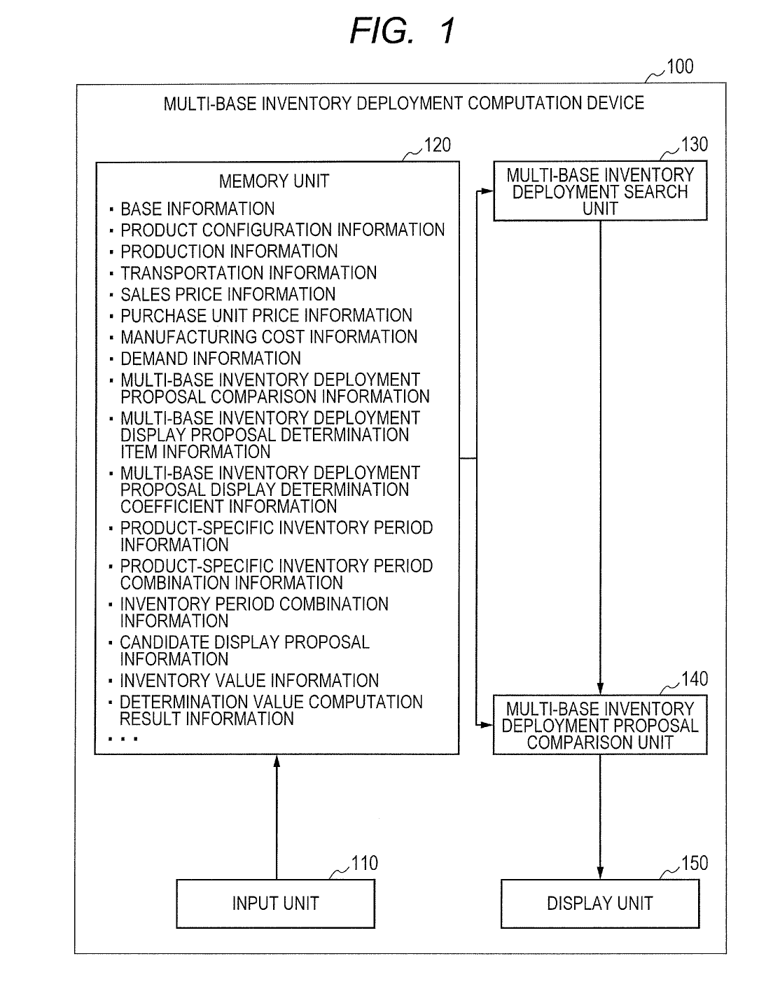

FIG. 1 shows an example of a block diagram for showing a functional configuration of a multi-base inventory deployment computation device 100 according to the embodiment. The multi-base inventory deployment computation device 100 includes an input unit 110, a memory unit 120, a multi-base inventory deployment search unit 130, a multi-base inventory deployment proposal comparison unit 140, and a display unit 150.

The input unit 110 reads, as external data, base information, product configuration information, production information, transportation information, sales price information, purchase unit price information, manufacturing cost information, demand information, multi-base inventory deployment proposal comparison information, and multi-base inventory deployment display proposal determination value information, and stores the same into the memory unit 120.

The memory unit 120 stores, as external data, the base information, the product configuration information, the production information, the transportation information, the sales price information, the purchase unit price information, the manufacturing cost information, the demand information, the multi-base inventory deployment proposal comparison information, and the multi-base inventory deployment display proposal determination value information.

The multi-base inventory deployment search unit 130 determines the inventory quantity of each base using the base information, the product configuration information, the production information, the transportation information, and the demand information that are stored in the memory unit.

Using the inventory quantity of each base determined by the multi-base inventory deployment search unit 130 and the base information, the product configuration information, the production information, the transportation information, the sales price information, the purchase unit price information, the manufacturing cost information, the demand information, the multi-base inventory deployment proposal comparison information, and the multi-base inventory deployment display proposal determination value information stored in the memory unit 120, the multi-base inventory deployment proposal comparison unit 140 performs an inventory management simulation to compute an evaluation value. On the basis of the computed evaluation value, display proposal selection conditions are evaluated to determine whether or not the inventory deployment proposal is displayed.

The display unit 150 is an interface for an inventory deployment decision-maker to display various operational screens and images in accordance with instructions of other functional units.

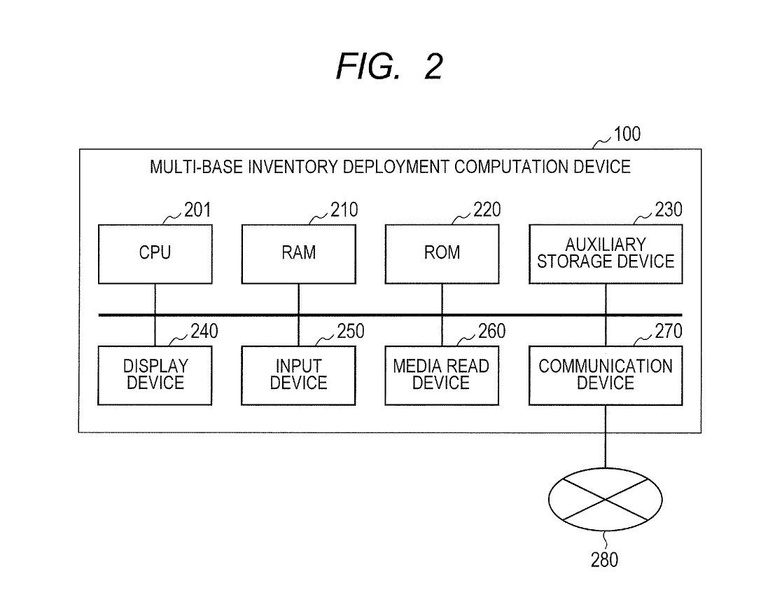

FIG. 2 is a block diagram for showing an example of a hardware configuration of the multi-base inventory deployment computation device 100 according to the embodiment.

The multi-base inventory deployment computation device 100 includes a CPU 201, a RAM 210, a ROM 220, an auxiliary storage device 230, a display device 240, an input device 250, a media read device 260, and a communication device 270.

The CPU 201 is a unit that executes various operations. The CPU 201 executes a predetermined multi-base inventory deployment computation program (not shown) loaded from the auxiliary storage device 230 to the RAM 210, so that various processes are executed.

The multi-base inventory deployment computation program is, for example, an application program that can be executed on an OS (Operating System) program.

The multi-base inventory deployment computation program may be, for example, installed from a portable storage medium to the auxiliary storage device 230 through the media read device 260.

The RAM 210 is a memory that stores a program executed by the CPU 201 and data necessary to execute the program.

The ROM 220 is a memory that stores a program necessary to start the multi-base inventory deployment computation device 100.

The auxiliary storage device 230 is, for example, a device such as an HDD (Hard Disk Drive), and may be an SSD (Solid State Drive) using a flash memory.

The display device 240 is, for example, a device such as a CRT display, an LCD (Liquid Crystal Display), or an organic EL (Electro-Luminescence) display.

The input device 250 is, for example, a device such as a keyboard, a mouse, or a microphone.

The media read device 260 is a device that reads information of a portable storage medium with portability such as a CD-ROM.

The communication device 270 inputs and outputs data into/from an external device through a network 280.

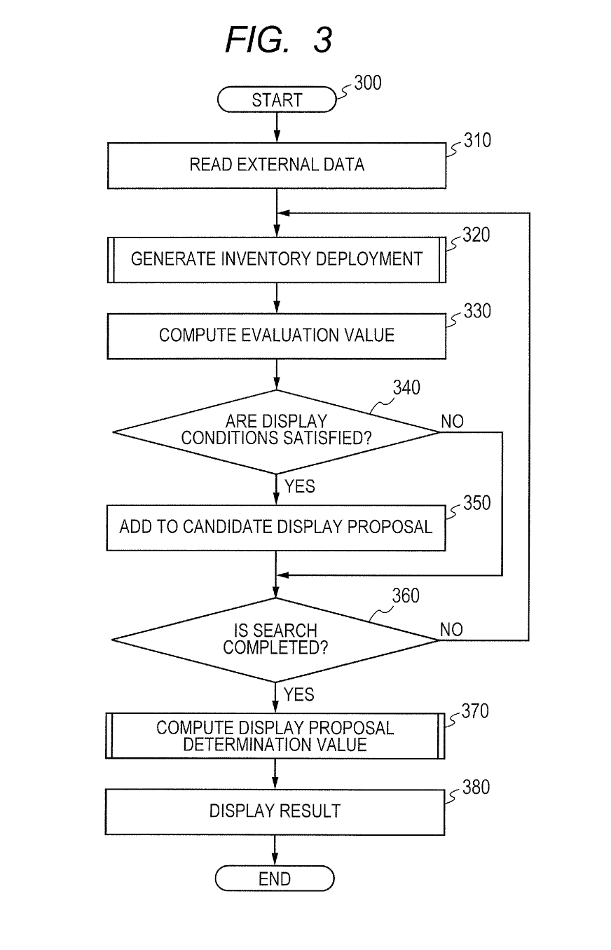

FIG. 3 shows an example of a multi-base inventory deployment computation processing flow for explaining a process of the multi-base inventory deployment computation device 100.

In the multi-base inventory deployment computation process, (1) an external data read process 310, (2) an inventory deployment generation process 320, (3) an evaluation value computation process 330, (4) a display condition satisfaction determination process 340, (5) a candidate display proposal addition process 350, (6) a search completion condition determination process 360, (7) a display proposal determination value computation process 370, and (8) a result display process 380 are performed.

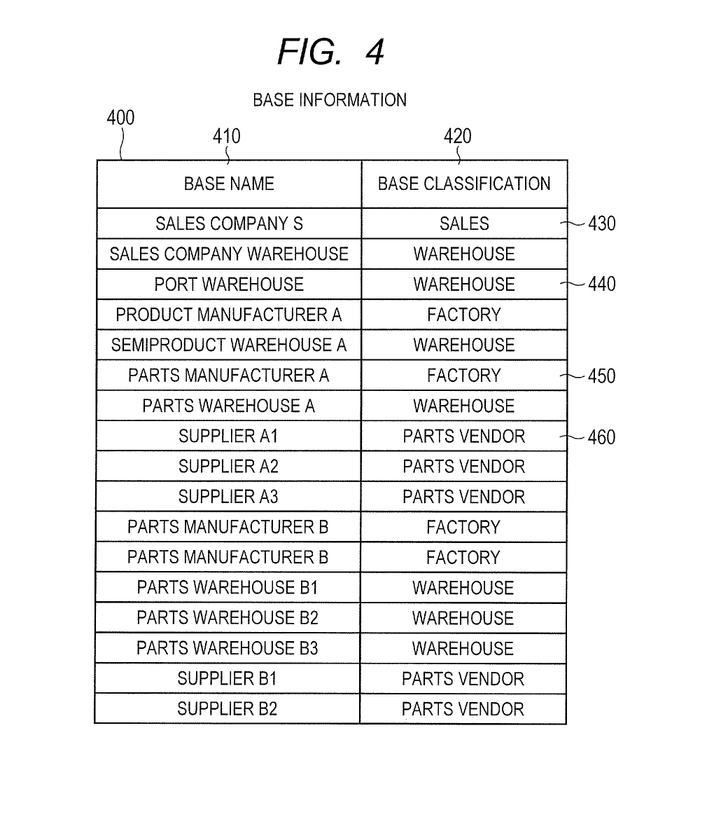

Hereinafter, the respective processes (1) to (8) of FIG. 3 will be described with reference to FIG. 4 to FIG. 28.

### (1) External Data Read Process 310

In (1) the external data read process 310 of FIG. 3, the base information, the product configuration information, the production information, the transportation information, the sales price information, the purchase unit price information, the manufacturing cost information, the demand information, the multi-base inventory deployment proposal comparison information, and the multi-base inventory deployment display proposal determination value information are read as external data.

In the external data read process 310, data loaded from the input unit 110 of FIG. 1 is stored into the memory unit 120. Specifically, an operation of the input device 250 of FIG. 2 by an inventory deployment decision-maker is accepted, and external data is loaded from the media read device 260 or the communication device 270 to be stored into the auxiliary storage device 230.

FIG. 4 shows an example of the base information 400. The base information 400 has, at least, data items defining a base name 410 and a base classification 420 representing processing content of the base. In the base classification, defined are sales 430 that generate demand, a warehouse 440 that stores inventories, a factory 450 that produces products from parts, a parts vendor 460 that provides parts, and the like.

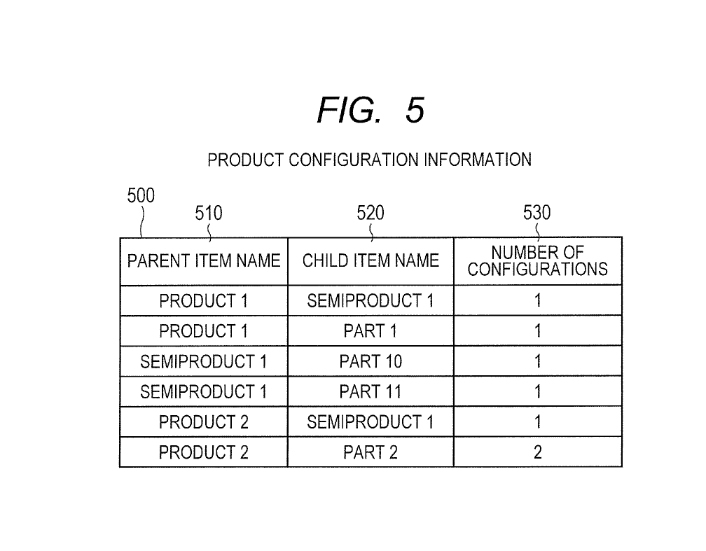

FIG. 5 shows an example of the product configuration information 500. The product configuration information 500 has, at least, data items defining a parent item name 510 that is a product to be produced, a child item name 520 used to produce the parent item, and the number of configurations 530 representing the number of child items necessary to produce the parent item of one unit.

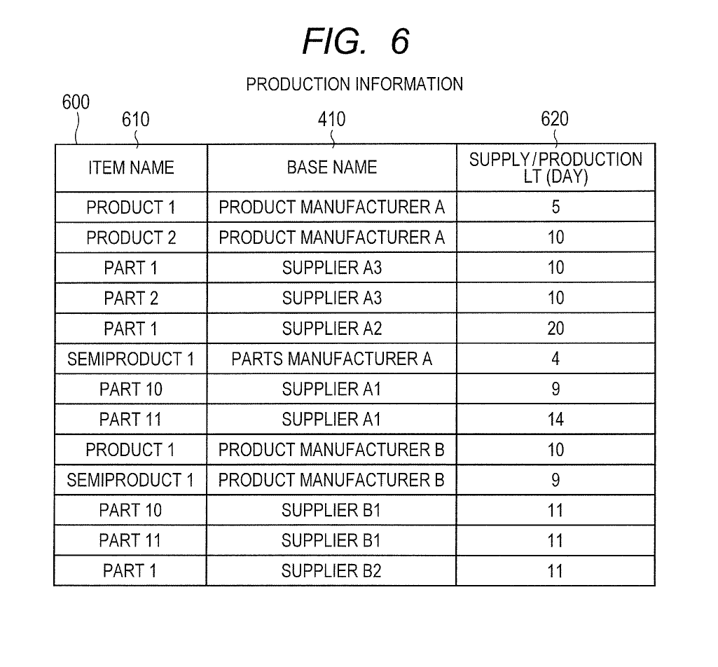

FIG. 6 shows an example of the production information 600. The production information 600 has, at least, data items defining an item name 610, a base name 410 that supplies and produces the item, a supply/production lead time (LT) 620 required in the case where the item is supplied and produced at the base, and the like.

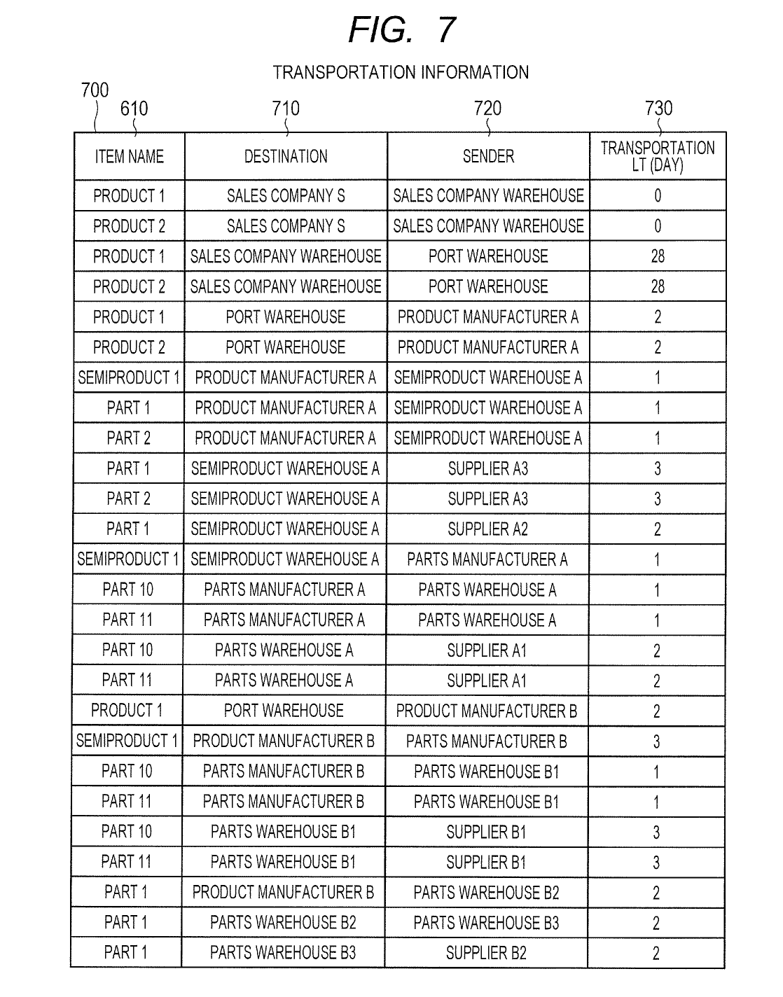

FIG. 7 shows an example of the transportation information 700. The transportation information 700 has, at least, data items defining the item name 610, a base name 710 at which the item arrives, and a base name 720 from which the item is shipped.

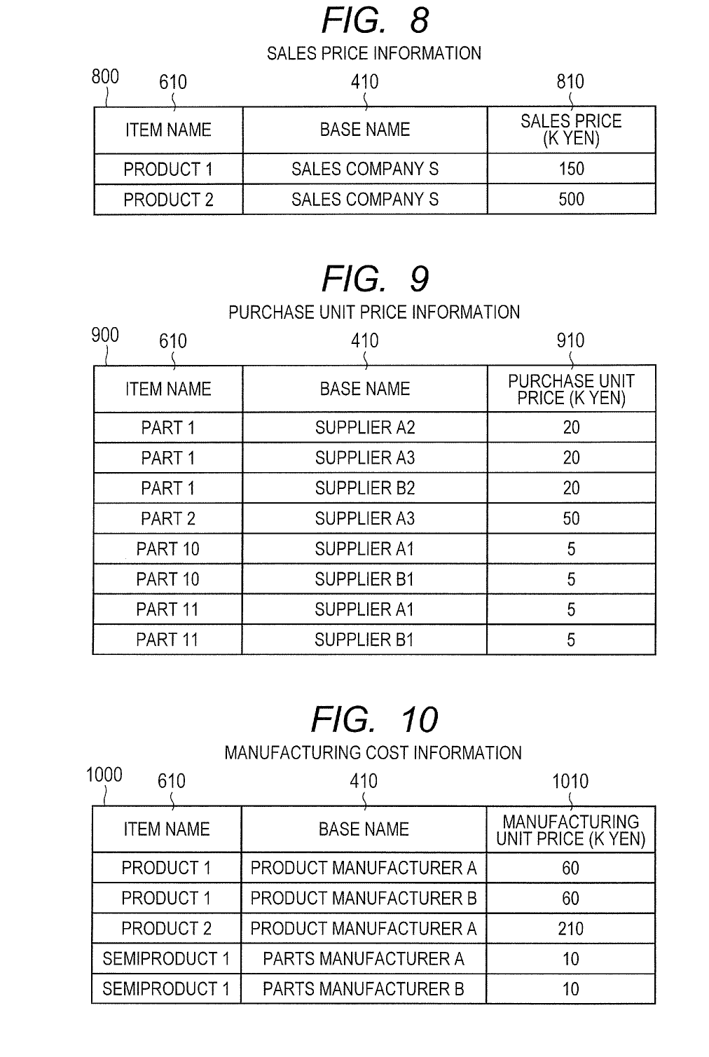

FIG. 8 shows an example of the sales price information 800. The sales price information 800 has, at least, data items defining the item name 610, the base name 410 where the item is sold, and a sales price 810 at which the item is sold at the base.

FIG. 9 shows an example of the purchase unit price information 900. The purchase unit price information 900 has, at least, data items defining the item name 610, the base name 410 from which the item is supplied, and a purchase unit price 910 at which the item is purchased from the base.

FIG. 10 shows an example of the manufacturing cost information 1000. The manufacturing cost information 1000 has, at least, data items defining the item name 610 to be manufactured, the base name 410 where the item is manufactured, and a manufacturing unit price 1010 in the case where the item is manufactured at the base.

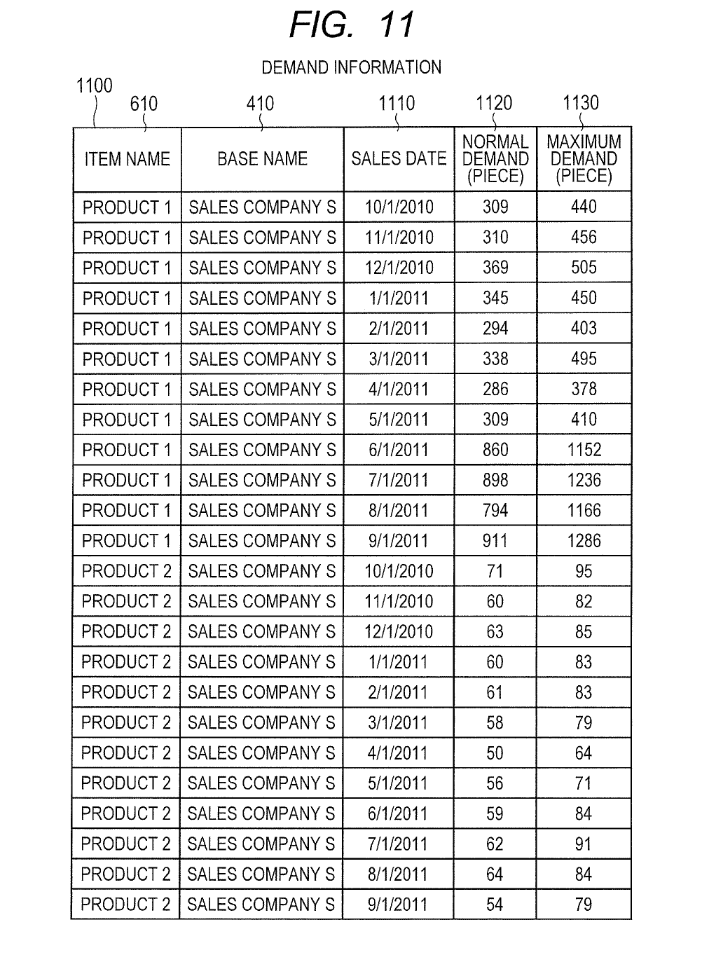

FIG. 11 shows an example of the demand information 1100. The demand information 1100 has, at least, data items defining the item name 610, the base name 410 where the item is sold, a sales date (that is the first date of a month and represents the month) 1110 when the item is sold at the base, demand (normal demand) 1120 in the case where the items are sold at the base on the sales date, and demand (maximum demand) 1130 to be maximally sold in the case where the items are sold at the base on the sales date.

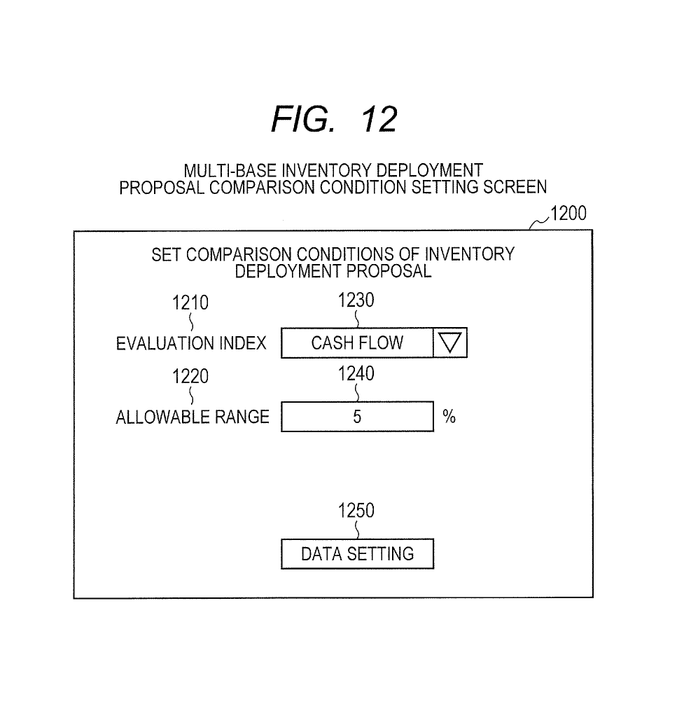

When the loading of the external data of FIG. 4 to FIG. 11 is completed as described above, entries of condition data are accepted on the screens shown in FIG. 12 to FIG. 14.

FIG. 12 shows a screen example 1200 on which the multi-base inventory deployment proposal comparison information is set. On the multi-base inventory deployment proposal comparison condition setting screen 1200, at least, an evaluation index 1210 and an allowable range 1220 of the evaluation index are set. Evaluation indexes having calculation methods recorded in the multi-base inventory deployment computation device 100 of the embodiment are preliminarily prepared as options in the evaluation index 1210. In the embodiment, the cash flow is selected (1230). Into the evaluation index 1210 and the allowable range 1220 of the evaluation index, input are values 1230 and 1240, respectively. It should be noted that the information may be set using not the entries on the screen but text files. The inventory deployment decision-maker inputs data and then operates a data setting icon 1250, so that the input unit reads the information input on the screen and stores the same into the memory unit 120 as the multi-base inventory deployment proposal comparison information.

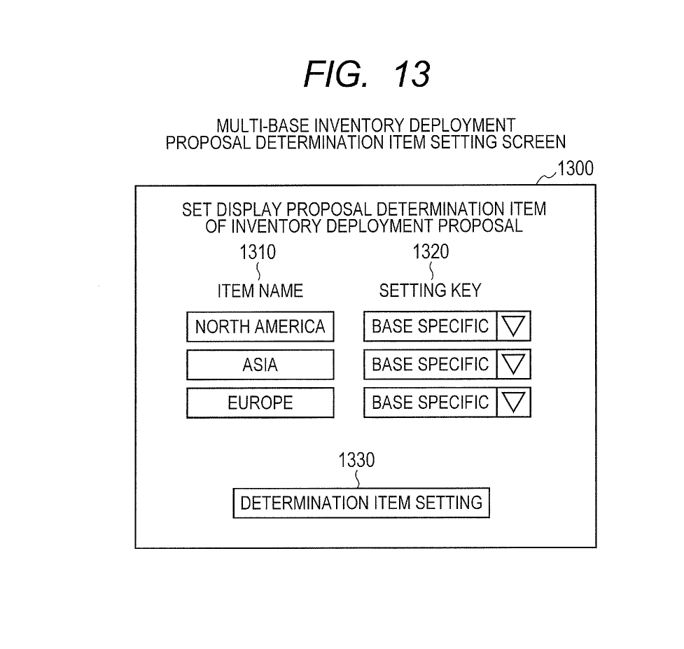

FIG. 13 shows an example of a setting screen 1300 of multi-base inventory deployment display proposal determination item information. On the multi-base inventory deployment display proposal determination item setting screen 1300, at least, a display proposal determination item name 1310 and a setting key 1320 for the item are set. The setting key 1320 for the display proposal determination item is selected from keys of the base information, the product configuration information, the production information, the transportation information, the sales price information, the purchase unit price information, the manufacturing cost information, and the demand information. It should be noted that the information may be set using not the entries on the screen but text files. The inventory deployment decision-maker inputs data and then operates a determination item setting icon 1330, so that the input unit reads the information input on the screen and stores the same into the memory unit 120 as the multi-base inventory deployment display proposal determination item information.

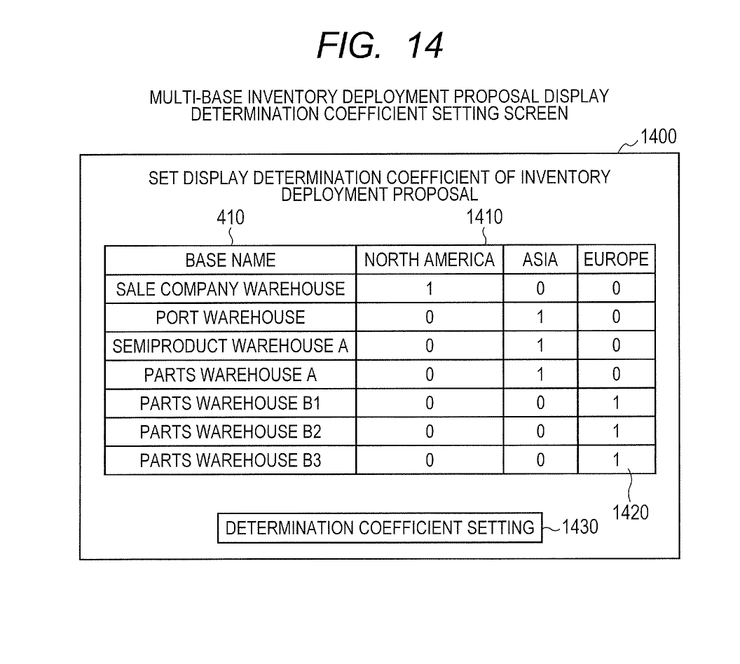

FIG. 14 shows an example of a multi-base inventory deployment proposal display determination coefficient setting screen 1400. On the multi-base inventory deployment proposal display determination coefficient setting screen 1400, the multi-base inventory deployment display proposal determination item information stored in the memory unit 120 is read, and a display determination coefficient 1420 is set for each display proposal determination item 1410 on the basis of each key 410. The information may be set using not the entries on the screen but text files. The inventory deployment decision-maker inputs data and then operates a determination coefficient setting icon 1430, so that the input unit reads the information input on the screen and stores the same into the memory unit as the multi-base inventory deployment proposal display determination coefficient information.

### (2) Inventory Deployment Generation Process

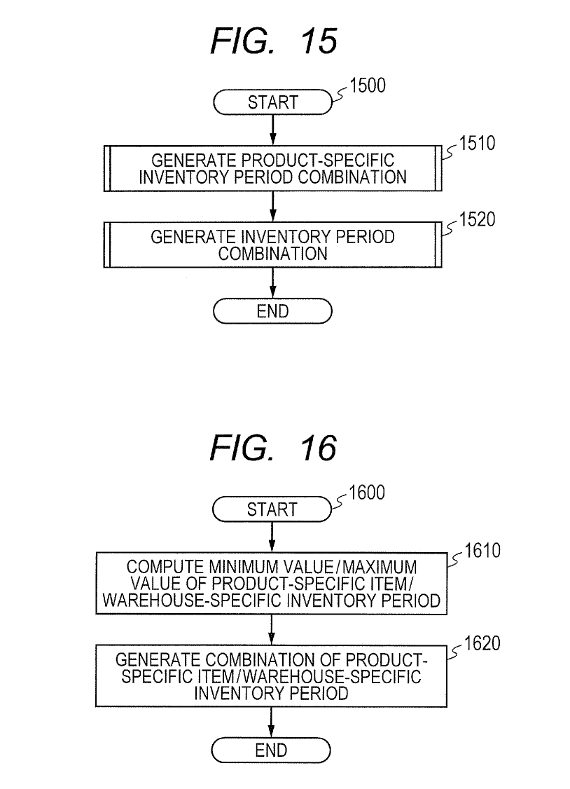

In (2) the inventory deployment generation process 320 of FIG. 3, a product-specific inventory period combination generation process 1510 and an inventory period combination generation process 1520 are performed as shown in a flow 1500 of FIG. 15.

The inventory deployment generation process 320 is executed by the multi-base inventory deployment search unit 130 using data of the memory unit 120 of FIG. 1. Specifically, while the program stored in the ROM 220 of FIG. 2 is loaded by the CPU 201, data of the auxiliary storage device 230 is read into the RAM 210 to execute the process, and the result is stored in the auxiliary storage device 230.

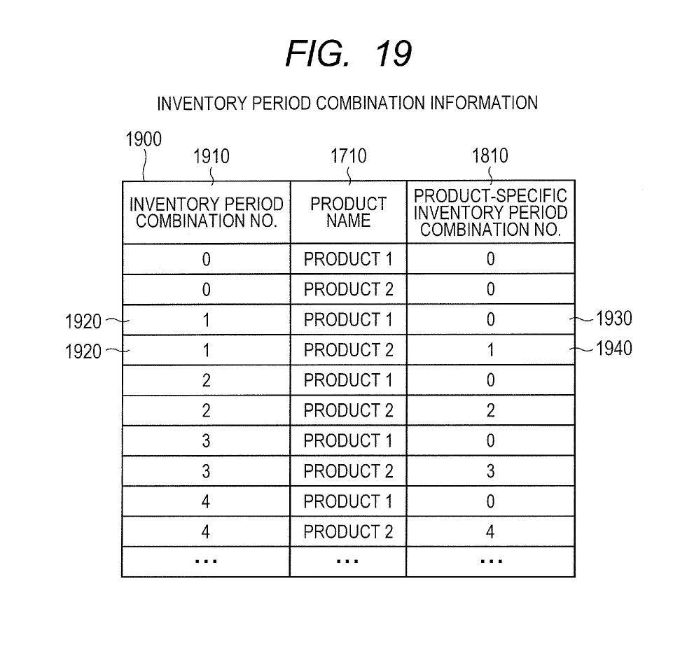

FIG. 15 shows the inventory deployment generation processing flow 1500. In the inventory deployment generation process 320, the product-specific inventory period combination generation 1510 is performed first, and the inventory period combination generation 1520 is performed secondly. Hereinafter, the first process 1510 will be described with reference to FIG. 16 to FIG. 18, and the second process 1520 will be described with reference to FIG. 19.

FIG. 16 shows a processing flow of the product-specific inventory period combination generation 1510 that is the first process of FIG. 15. A product-specific inventory period combination generation process 1600 includes two processes. A minimum value/maximum value computation process 1610 of a product-specific item/warehouse-specific inventory period is performed first, and combination generation 1620 of a product-specific item/warehouse-specific inventory period is performed secondly.

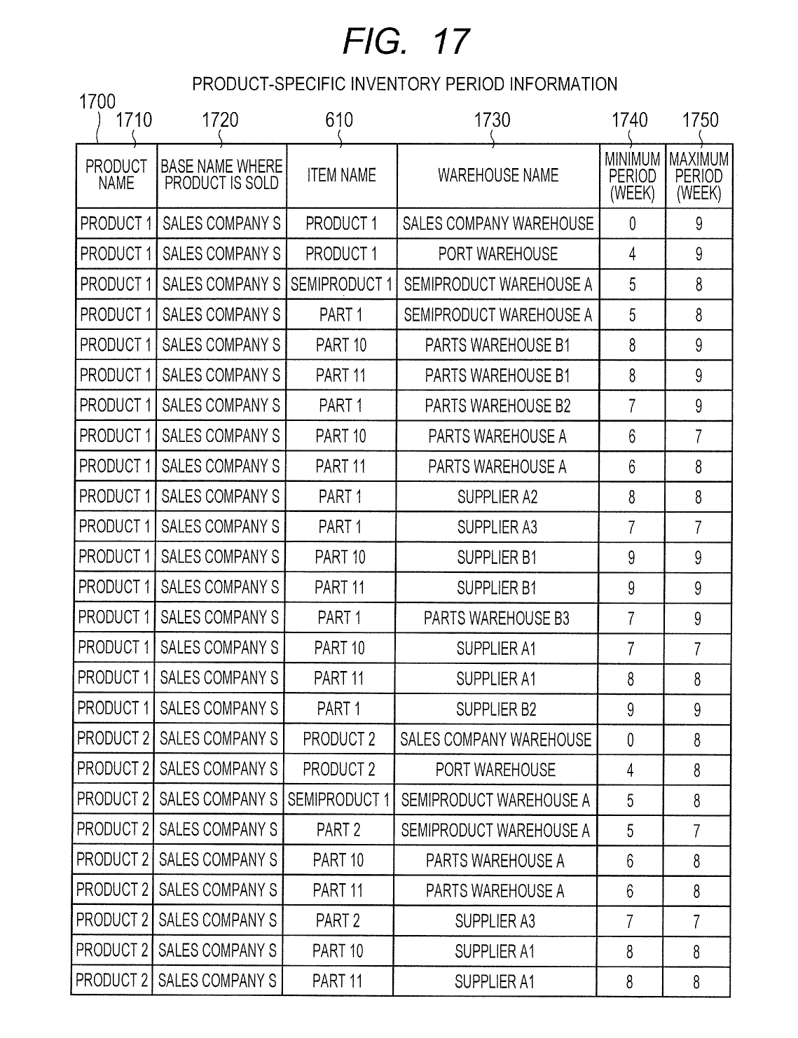

In the minimum value/maximum value computation process 1610 of the product-specific item/warehouse-specific inventory period that is the first process of FIG. 16, the minimum value and the maximum value of an inventory period for each item and each warehouse that stores the item are computed according to the product by inputting the base information 400 of FIG. 4, the product configuration information 500 of FIG. 5, the production information 600 of FIG. 6, and the transportation information 700 of FIG. 7, so that the product-specific inventory period information 1700 of FIG. 17 is output.

FIG. 17 shows an example of the product-specific inventory period information 1700. The product-specific inventory period information 1700 has, at least, data items defining a product name 1710, a base name 1720 where the product is sold, the item name 610 that configures the product, a warehouse name 1730 that stores the item, and a minimum period 1740 and a maximum period 1750 of the inventory period of the product/sales base/item/warehouse.

A generation method of the product-specific inventory period information 1700 will be described. Using the parent item and the child item related to each product registered in the product configuration information 500 of FIG. 5 as keys, the item name 610 of the corresponding product and part is extracted from the transportation information 700 of FIG. 7, and is associated with the sender 720 and the destination 710 in the same row, so that a distribution network related to each product is formed.

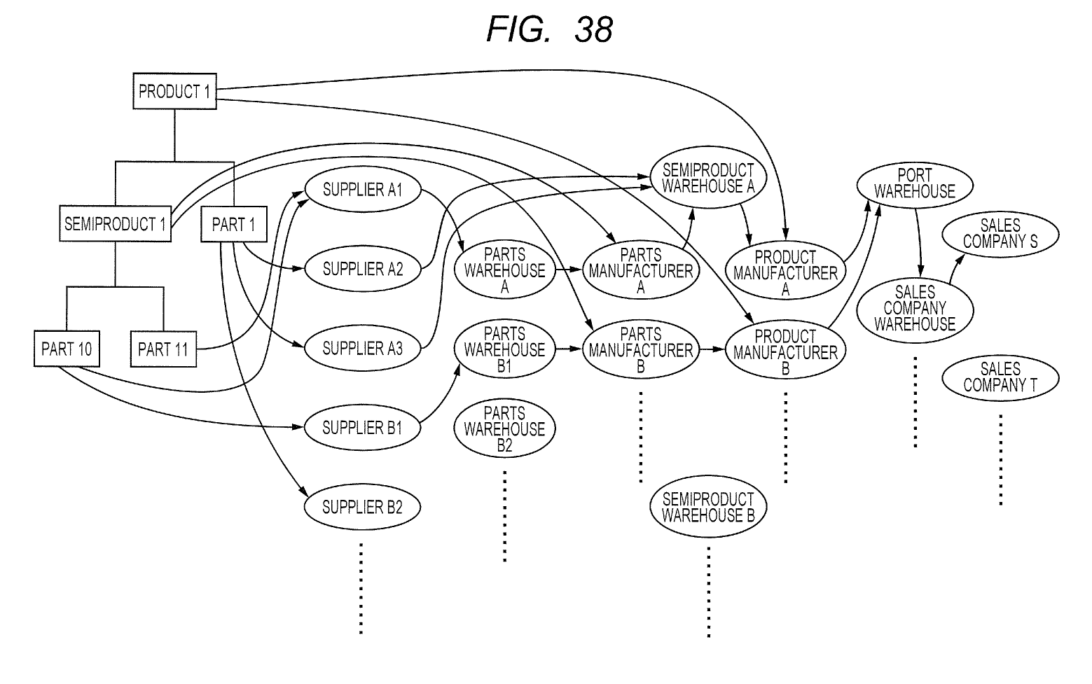

A model image of the distribution network is shown in FIG. 38. A product configuration tree of a product 1 is created on the basis of the product configuration information 500 of FIG. 5 on the left side of FIG. 38, and nodes with base names written in oval frames are arranged on the right side thereof so as to configure supply chains.

Using each item of the product configuration tree represented by rectangular frames as a key, for example, parts 10 are supplied from a supplier A1 and a supplier B1 according to the transportation information 700 of FIG. 7. In addition, the parts 10 are transported from the supplier A1 to a parts warehouse A, and from the supplier B1 to a parts warehouse B1. Association of data represented using arrows is created on the model of FIG. 38. Further, the parts 10 are transported from the parts warehouse A to a parts manufacturer A, and from the parts warehouse B1 to a parts manufacturer B. The transportations are created using arrows on the model.

Further, semiproducts 1 are manufactured at the parts manufacturer A and the parts manufacturer B in accordance with the transportation information 700. In addition, the semiproducts 1 are transported from the parts manufacturer A to a product manufacturer A via a semiproduct warehouse A, and from the parts manufacturer B to a product manufacturer B. The transportations are created using arrows on the model. Further, products 1 are manufactured at the product manufacturer A and the product manufacturer B, and are transported to a sales company S via a port warehouse and a sales company warehouse. The transportations are created using arrows on the model. As described above, association of route data is created on the model of the distribution network for each product using the all items as keys.

Further, the supply and production lead time (LT) 620 of FIG. 6 is set at each base on the routes of the distribution network, and a transportation LT 730 of FIG. 7 is set at each transportation route between the bases, so that each lead time on the distribution network is determined. Further, using the base information 400 of FIG. 4, which base serves as the warehouse 440 of a candidate inventory point or which base serves as the factory 450 where the manufacturing cost is incurred is identified. The model of the distribution network is configured on the RAM 210 of the multi-base inventory deployment computation device 100.

The minimum period 1740 of FIG. 17 is computed as the sum of the supply and production lead time and the transportation lead time from the time the item is shipped from the item/warehouse to the time the item arrives at the sales base of the product. On the model of the distribution network, the lead times of the routes of the distribution network from the warehouse base or the supplier base to the sales base are added to each other.

Further, the maximum period 1750 of FIG. 17 is computed for the item or the all child parts configuring the item by totaling the maximum value of the sum of the supply/production/transportation lead times from the time each child part is shipped from the parts vendor to the time the child part arrives at the item/warehouse and the sum of the production lead time and the transportation lead time from the time the item is shipped from the item/warehouse to the time the item arrives at the sales base of the product. On the model of the distribution network, the sum of the lead times on the routes of the distribution network from the all supplier bases to the sales bases via the warehouse base is computed, and the maximum total value thereof is used as the maximum period 1750.

In this case, it is necessary to consider that the inventory quantity required for a warehouse is proportional to the lead time of supply/production/transportation for the warehouse. For example, in the case where products or parts are insufficient in quantity, the warehouse becomes out of stock until the products or parts arrive due to waiting time from the time the products or parts are transported from another place to the time the products or parts are replenished. In order to avoid the out-of-stock, it is necessary to maintain inventories against the shortages in the waiting time. The inventory period of FIG. 17 means the waiting time, and is used to compute the inventory quantity. The minimum period 1740 corresponds to the minimum inventory quantity that is possibly maintained at a base, and the maximum period 1750 corresponds to the maximum inventory quantity that is possibly maintained at a base. The final inventory quantity of each base is determined in consideration of the relation with the inventory quantities of other bases on the distribution network.

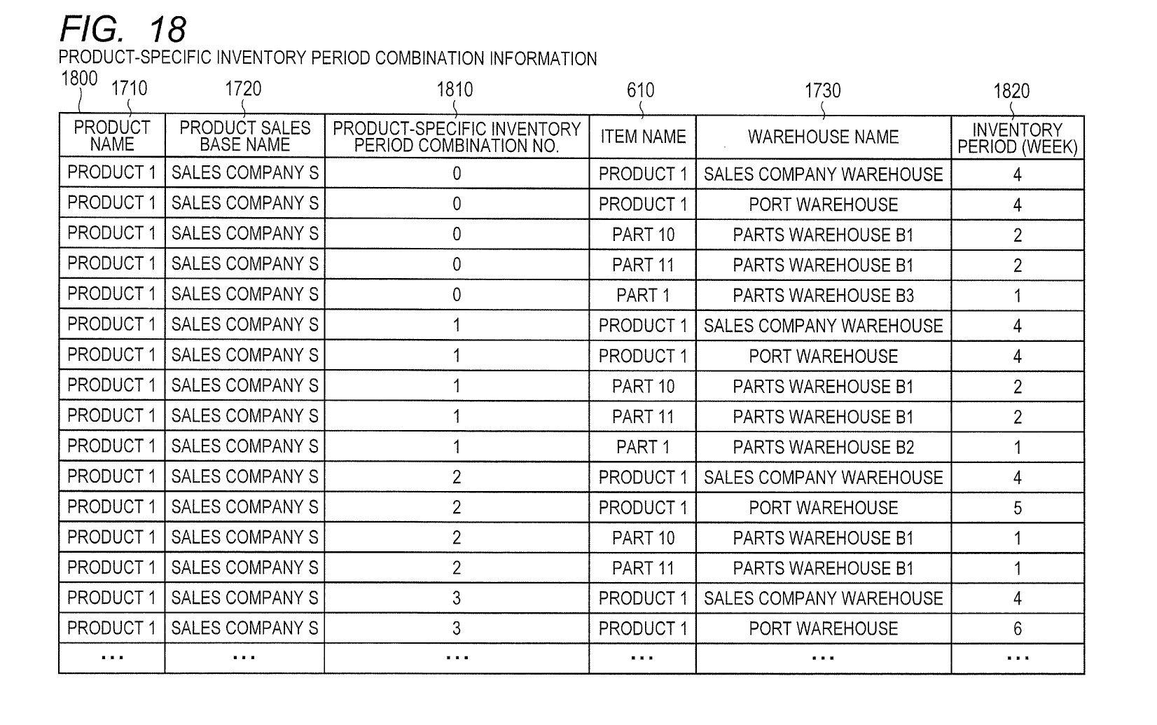

In the product-specific item/warehouse-specific inventory period combination generation 1620 that is the second process of FIG. 16, all combinations of product-specific inventory periods in which the inventory period (inventory quantity) on a week basis allocated to each warehouse base on the routes falls between the minimum period and the maximum period of the corresponding product-specific inventory period information and the total of the inventory periods allocated to the respective warehouse bases is the maximum period of the corresponding routes on the distribution network are obtained for the all routes on the distribution network by inputting the product-specific inventory period information 1700 of FIG. 17 and the model of the distribution network. The obtained combinations of product-specific inventory periods are numbered, and inventory period combination information 1800 of FIG. 18 is generated to be stored in the memory unit.

FIG. 18 shows an example of the product-specific inventory period combination information 1800. FIG. 18 shows an example of the product 1. Even in the case of the product 2, the similar combination information is generated. The product-specific inventory period combination information 1800 stores, at least, data items defining a product name 1710, a base name 1720 where the product is sold, a product-specific inventory period combination number 1810, an item name 610 configuring the product, a warehouse name 1730 that stores the item, and an inventory period 1820 in the product-specific inventory period combination number of the product/sales base/item/warehouse.

The inventory period means which part of the supply and production lead times and the transportation lead times of the whole distribution network is covered in the warehouse of each base. The inventory period of each base can be a value between the minimum period 1740 and the maximum period 1750 of FIG. 17. In the embodiment, the inventory period is defined using a value on a week basis. In some combination (corresponding to the product-specific inventory period combination number 1810 of the drawing), the sum of the inventory periods 1820 of the all bases on the distribution network corresponds to that of the supply and production lead times and the transportation lead times of the whole distribution network.

Referring back to FIG. 15 again, in the inventory period combination generation 1520 that is the second process, inventory period combination information 1900 of FIG. 19 is generated by inputting the product-specific inventory period combination information 1800 of FIG. 18 created for each product type, and is stored in the memory unit 120.

FIG. 19 shows an example of the inventory period combination information 1900. The inventory period combination information 1900 stores, at least, data items of an inventory period combination number 1910, the product name 1710, and the product-specific inventory period combination number 1810 of the product in the inventory period combination number.

A method of creating the inventory period combination information 1900 will be described. By inputting the product-specific inventory period combination information 1800 of FIG. 18, the product-specific inventory period combination information 1810 of FIG. 18 is selected for each product type, and the inventory period combination information 1900 can be created by combining these pieces of information. For example, in the case of the inventory period combination No. 1 (1920) of FIG. 19, 0 (1930) is selected as the product-specific inventory period combination number of the product 1, and 1 (1940) is selected as the product-specific inventory period combination number of the product 2. Using the inventory period combination information 1900, inventory deployment that differs depending on a product type can be considered for the all product types.

### (3) Evaluation Value Computation Process

In (3) the evaluation value computation process 330 of FIG. 3, the amounts of supply, production, sales and transportation by item, base, and time are computed for one generated inventory period combination using an existing evaluation value computing method to compute the evaluation value. In the embodiment, cash flow is computed as the evaluation value.

The evaluation value computation process 330 is executed by the multi-base inventory deployment proposal comparison unit 140 using the data of the memory unit 120 of FIG. 1. Specifically, while the program stored in the ROM 220 of FIG. 2 is loaded by the CPU 201, data of the auxiliary storage device 230 is read into the RAM 210 to execute the process, and the result is stored in the auxiliary storage device 230.

The cash flow is computed for each inventory period combination number 1910 of FIG. 19 by inputting the sales price information 800 of FIG. 8, the purchase unit price information 900 of FIG. 9, the manufacturing cost information 1000 of FIG. 10, the demand information 1100 of FIG. 11, the product-specific inventory period combination information 1800 of FIG. 18, and the inventory period combination information 1900 of FIG. 19.

A procedure of computing the cash flow will be described. For each inventory period combination number 1910 shown in FIG. 19, the cash flow is computed in such a manner that the total of sales and the total of costs are obtained for the period 1110 defined in the demand information of FIG. 11, and the total of costs is subtracted from the total of sales.

A method of computing the total of sales will be described. The product 1710 corresponding to some inventory period combination number 1910 is obtained from the inventory period combination information of FIG. 19. Next, the normal demand 1120 of the demand information of FIG. 11 is multiplied by the sales price information 800 of FIG. 8 for each product 1710, so that the sales amount of each month is computed. The results obtained by repeating the computation for the all periods of the demand information 1100 are added to each other, so that the total of sales can be obtained.

A method of computing the total of costs will be described. The product 1710 corresponding to some inventory period combination number 1910 is obtained from the inventory period combination information of FIG. 19, and the amount of upper variation on a week basis is computed for each product 1710 from the demand information 1100 of FIG. 11 using the following equation.

Amount of upper variation=(maximum demand−normal demand)/4 (Equation 1)

Next, the product-specific inventory period combination number 1810 corresponding to the inventory period combination number 1910 is specified using the inventory period combination information 1900 of FIG. 19. For the specified product-specific inventory period combination number 1810, the inventory period 1820 of each base of FIG. 18 is specified. The inventory period 1820 is multiplied by the amount of variation, so that the inventory quantity necessary for each base in one month is obtained. Further, the cost of each base is multiplied by the inventory quantity, so that the inventory value of each month is obtained. The cost of each base is computed in such a manner that the cost incurring on the route to each base is selected in the manufacturing cost information 1000 of FIG. 10 and is added to the purchase unit price information 900 of FIG. 9. The results obtained by repeating the above-described procedure for the all periods of the demand information defined in the demand information 1100 of FIG. 11 are added to each other, so that the total of costs can be obtained.

### (4) Display Condition Satisfaction Determination Process

In (4) the display condition satisfaction determination process 340 of FIG. 3, it is determined whether or not the inventory period combination 1910 satisfies the display condition using the evaluation value computed in (3) the evaluation value computation process 330.

The display condition satisfaction determination process 340 is executed by the multi-base inventory deployment proposal comparison unit 140 of FIG. 1. Specifically, while the program stored in the ROM 220 of FIG. 2 is loaded by the CPU 201, data of the auxiliary storage device 230 is read into the RAM 210 to execute the process, and the result is stored in the auxiliary storage device 230.

In the embodiment, the cash flow is 95% or higher of the maximum value in the display condition according to the condition 1240 set in the allowable range 1220 of FIG. 12. Accordingly, the maximum value of the cash flow until the inventory period combination is computed is compared with the inventory period combination 1910 to determine whether or not the inventory period combination 1910 is 95% or higher of the maximum value of the cash flow.

### (5) Addition to Candidate Display Proposal

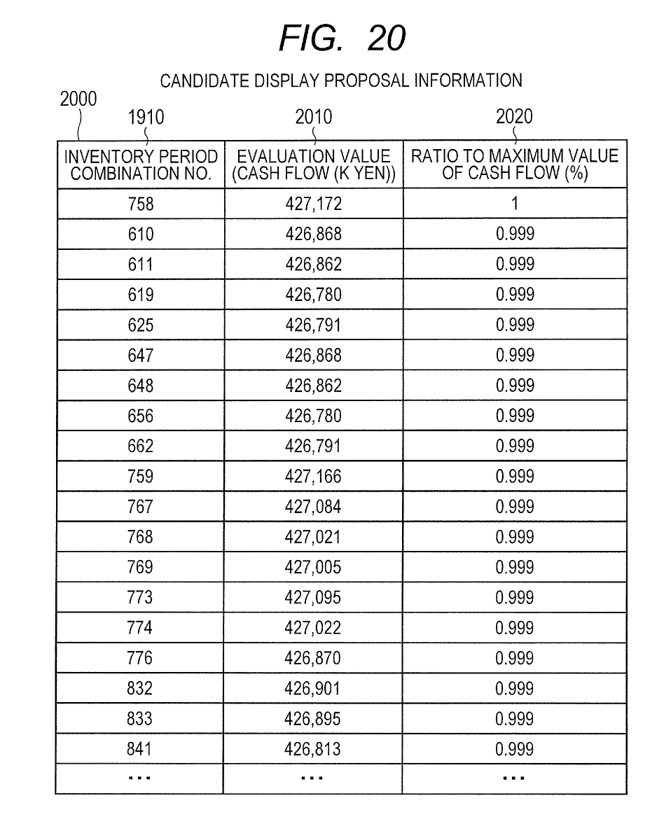

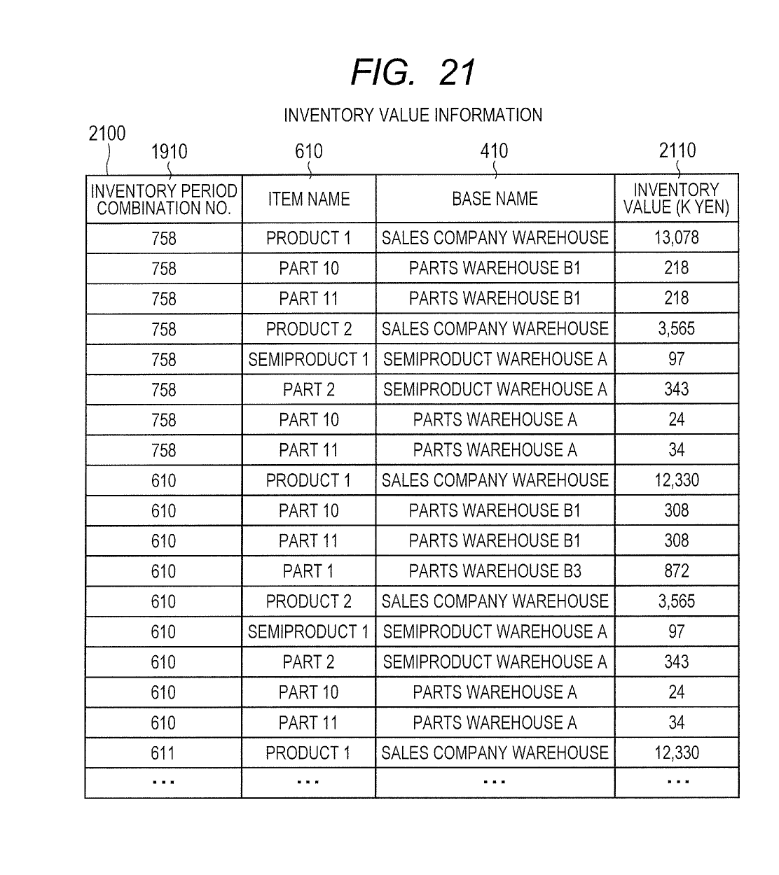

In (5) the addition to candidate display proposal 350 of FIG. 3, in the case where the result of (4) the display condition satisfaction determination process 340 satisfies the display condition, the result is stored in the memory unit 120 as candidate display proposal information 2000 shown in FIG. 20. Further, the inventory value by item and base of the inventory period combination is stored in the memory unit 120 as inventory value information 2100 shown in FIG. 21.

In the case where the value of the cash flow of the inventory period combination 1910 is the maximum value of new cash flow, registration to the maximum value of the new cash flow is performed. In addition, it is determined whether or not the inventory period combination 1910 for which it has been determined to satisfy the display condition and which is stored in the candidate display proposal information 2000 is 95% or higher of the maximum value of the new cash flow. The inventory period combination for which it has been determined not to satisfy the display condition is deleted from the candidate display proposal information 2000.

The addition to candidate display proposal 350 is executed by the multi-base inventory deployment proposal comparison unit 140 of FIG. 1. Specifically, while the program stored in the ROM 220 of FIG. 2 is loaded by the CPU 201, data of the auxiliary storage device 230 is read into the RAM 210 to execute the process, and the result is stored in the auxiliary storage device 230.

FIG. 20 shows an example of the candidate display proposal information 2000. The candidate display proposal information 2000 stores, at least, data items of the inventory period combination number 1910 as a candidate display proposal, and an evaluation value 2010 of the inventory period combination number. Further, the candidate display proposal information 2000 may include data determining that the evaluation value of the inventory period combination number satisfies the display condition. In the case of the embodiment, a ratio 2020 of the cash flow of the inventory period combination relative to the maximum value of the cash flow is defined. In the table of the drawing, the inventory period combination numbers with a ratio of 95% (0.95) or higher relative to the maximum value of the cash flow are stored, so that the ratios 2020 of the cash flow are arranged in descending order.

FIG. 21 shows an example of the inventory value information 2100. The inventory value information 2100 stores, at least, data items of the inventory period combination number 1910, the item name 610, the base name 410, and an inventory value 2110 of the base for the item in the inventory period combination.

In the inventory value 2110, the result obtained in the course of the computation of the total of costs described in the computation procedure of the cash flow in (3) the evaluation value computation process 330 is recorded.

### (6) Search Completion Condition Determination Process

In the search completion condition determination process 360 of FIG. 3, it is determined whether or not the search is completed.

The search completion condition determination process 360 is executed by the multi-base inventory deployment proposal comparison unit 140 of FIG. 1. Specifically, while the program stored in the ROM 220 of FIG. 2 is loaded by the CPU 201, data of the auxiliary storage device 230 is read into the RAM 210 to execute the process, and the result is stored in the auxiliary storage device 230.

In the case of the embodiment, the process is completed after the all inventory period combinations 1910 are searched, and thus the search is completed when the generation of the all inventory period combinations 1910 is completed.

### (7) Display Proposal Determination Value Computation Process

In the display proposal determination value computation process 370 of FIG. 3, the inventory value information 2100 stored in the memory unit is aggregated with the key 1320 of the display proposal determination item set on the multi-base inventory deployment proposal determination item setting screen of FIG. 13.

The display proposal determination value computation process 370 is executed by the multi-base inventory deployment proposal comparison unit 140 of FIG. 1. Specifically, while the program stored in the ROM 220 of FIG. 2 is loaded by the CPU 201, data of the auxiliary storage device 230 is read into the RAM 210 to execute the process, and the result is stored in the auxiliary storage device 230.

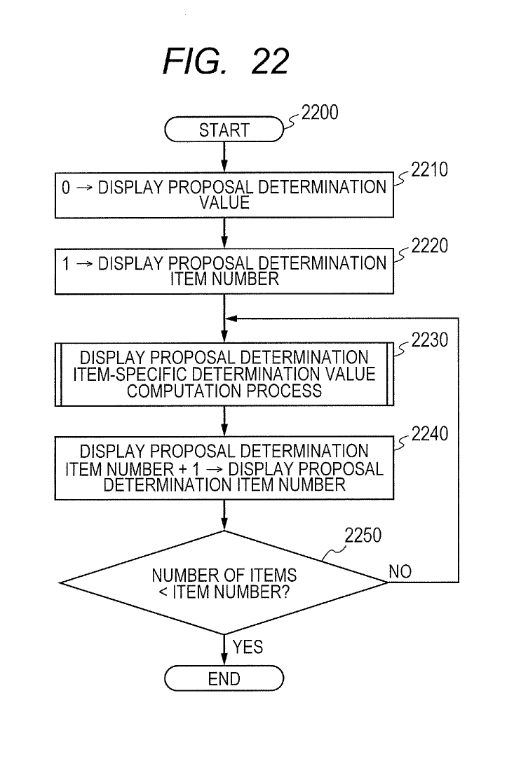

In the embodiment, the key 1320 of the display proposal determination item represents a base, and thus the inventory value information 2100 is aggregated according to the base. Hereinafter, the process will be described with reference to FIG. 22 to FIG. 25.

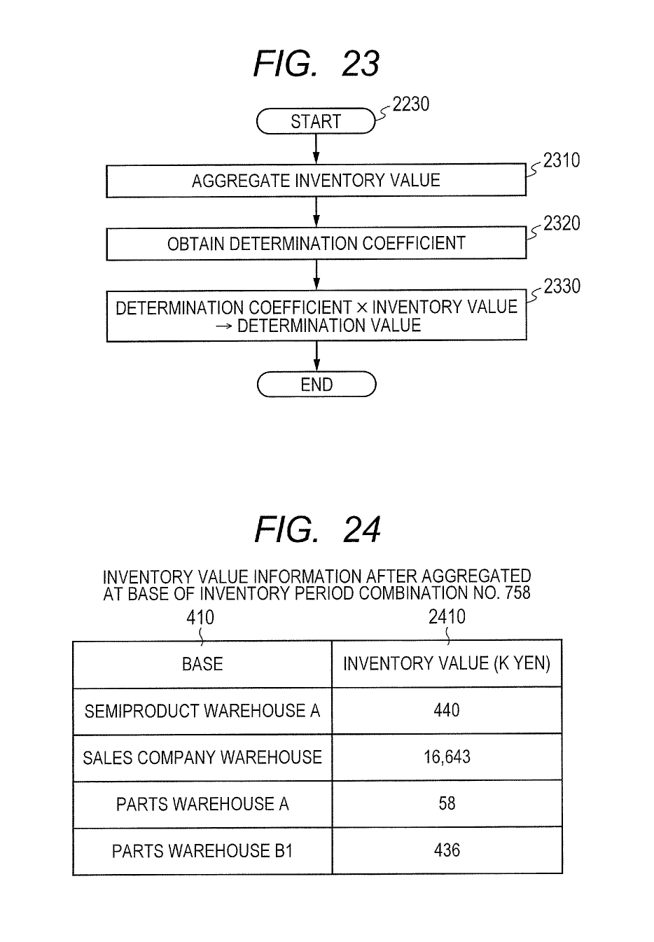

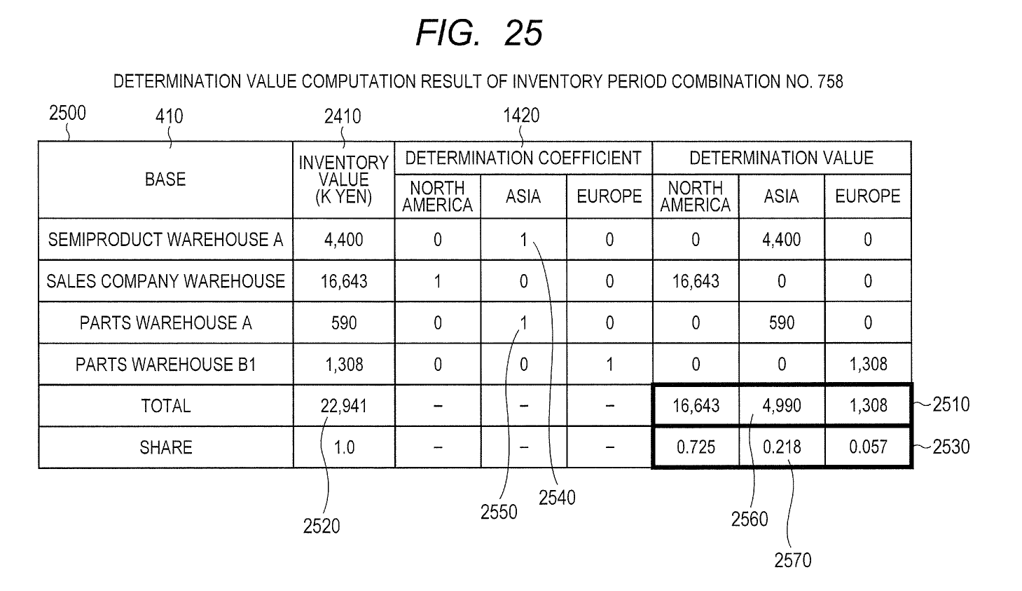

FIG. 22 shows an example of a display proposal determination value computation processing flow. In a display proposal determination value computation process 2200, 0 is assigned to a display proposal determination value (2210) as an initialization process, and 1 is assigned to a display proposal determination item number (2220). Next, a display proposal determination item-specific determination value computation process 2230 to be described using FIG. 23 is performed, and 1 is added to the display proposal determination item number (2240). In addition, the process is repeated until the display proposal determination item number matches the number of items (2250). FIG. 23 shows an example of a display proposal determination item-specific determination value computation processing flow. In a display proposal determination item-specific determination value computation process 2230, an inventory value aggregation process 2310 is performed first. In the process, the item-specific and base-specific inventory value of the inventory period combination is read by inputting the inventory value information 2100 of FIG. 21, and is aggregated with the key of the display proposal determination item. As a result, the inventory value information as shown in FIG. 24 can be obtained. Next, the determination coefficient 1420 of the display proposal determination item is obtained from the multi-base inventory deployment proposal display determination coefficient information that is stored in the memory unit 120 and is input on the screen of FIG. 14, and the inventory value computed in the inventory value aggregation process is multiplied by the determination coefficient 1420, so that the determination value is computed. As a result, the determination value computation results as shown in FIG. 25 can be obtained.

FIG. 24 shows an example in which an inventory value 2410 of inventory period combination No. 758 is aggregated with the base 420 that is the key 1320 of the display proposal determination item in the embodiment.

FIG. 25 shows an example of a determination value computation result 2500 of inventory period combination No. 758 in the embodiment. In the drawing, using regional information of the bases registered with the determination coefficient 1420, the inventory value 2410 is aggregated by region (2510), and a share 2530 relative to a total 2520 is computed. For example, the bases existing in the Asia region are a semiproduct warehouse A (2540) and a parts warehouse A (2550), and thus the inventory value is multiplied by the determination coefficient to be added to another, so that a total 2560 of the inventory values of the bases existing in the Asia region can be computed. Using this, a share 2570 in Asia can be computed. The shares in North America and Europe can be similarly obtained. Further, it is conceivable that the regional information can be classified by country such as South America, and the number of countries is not limited. Further, it is conceivable that instead of regions, classification by circulated currency such as a U.S. dollar currency zone and a Euro currency zone can be used.

### (8) Result Display

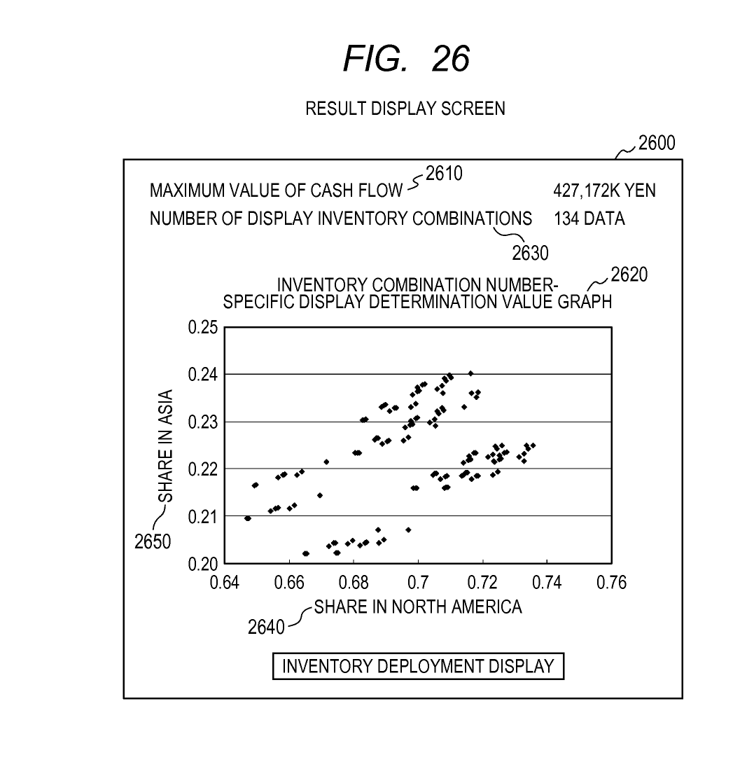

In (8) the result display 380 of FIG. 3, screens shown in FIG. 26 to FIG. 28 are displayed.

The result display is displayed on the display unit 150 of FIG. 1. Specifically, while the program stored in the ROM 220 of FIG. 2 is loaded by the CPU 201, data of the auxiliary storage device 230 is read into the RAM 210 to be output to the display device 240. Further, an operation of the input device 250 by the inventory deployment decision-maker is accepted, and the program stored in the ROM 220 is loaded by the CPU 201 on the basis of the information. In addition, data of the auxiliary storage device 230 is read to the RAM 210, and the output of the display device 240 is changed. It should be noted that when the result display is completed, the information stored in the auxiliary storage device 230 is saved.

FIG. 26 shows an example of a result display screen 2600. The result display screen 2600 displays the maximum value of cash flow 2610 and the number of inventory combinations 2630 displayed on an inventory period combination number-specific display determination value graph 2620 by inputting the candidate display proposal information 2000 of FIG. 20 and the determination value computation result 2500 of FIG. 25. The number of inventory combinations displayed on the inventory period combination number-specific display determination value graph is set at the number of display proposals or smaller determined in accordance with the multi-base inventory deployment proposal comparison information stored in the memory unit 120. In the embodiment, of 10⁵ display proposals, the number of inventory combinations satisfying a ratio of 95% or higher relative to the maximum value of cash flow as the display condition is only 134, and thus 134 is displayed.

In the inventory combination number-specific display determination value graph 2620, the horizontal axis represents an inventory combination number and the vertical axis represents a display determination value in the case of one display proposal determination item. In the case of two display proposal determination items, each of the vertical axis and the horizontal axis represents a display proposal determination item. In the case of three display proposal determination items, the graph may be three-dimensionally displayed, or may be two-dimensionally displayed by selecting two. In the case of four or more, the graph is displayed by selecting two or three. Further, plural items are combined to generate new items by a main component analysis, and the graph may be displayed while the axes represent the new items. In the embodiment, the horizontal axis represents a share in North America 2640 and the vertical axis represents a share in Asia 2650 as the display proposal determination items. Even in the case where the cash flow is the same according to the drawing, the region where the inventories are intensively deployed can be selected by comparison among cases where the share in North America is low but the share in Asia is high (on the upper left side of the graph) and where the share in North America is high but the share in Asia is low (on the lower right side of the graph).

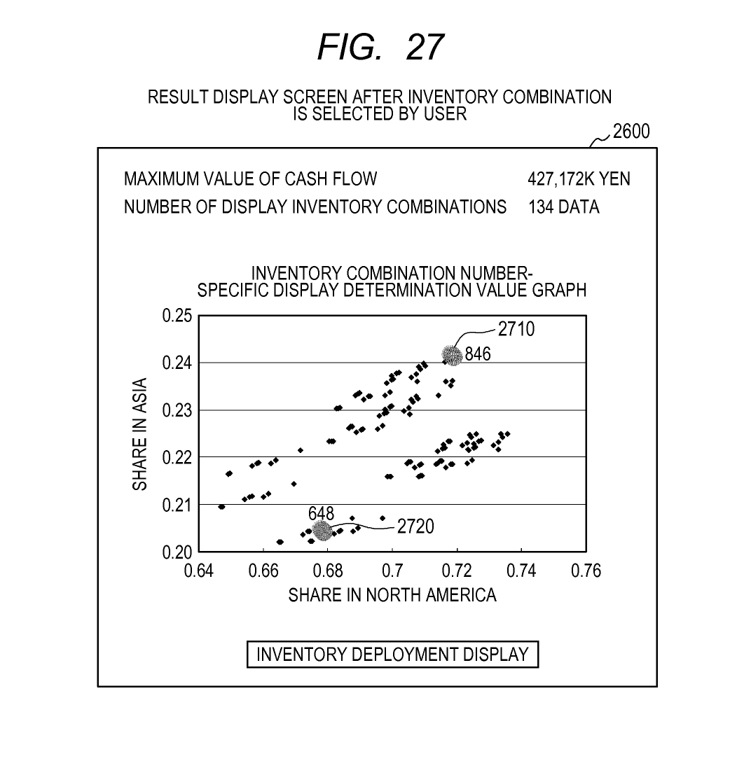

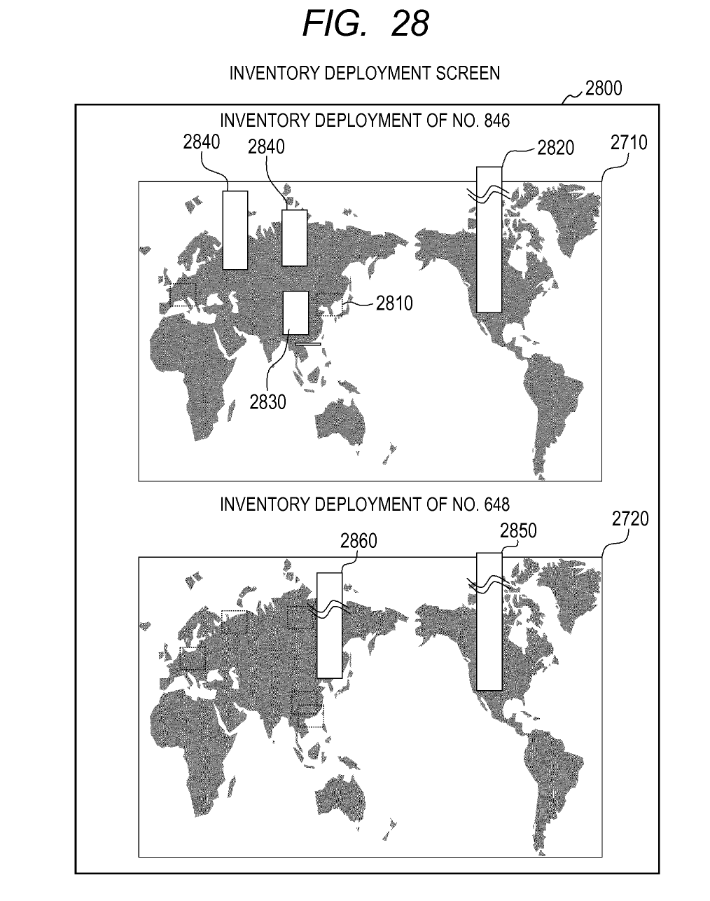

FIG. 27 shows a screen example in a state where the inventory deployment decision-maker selects points on the inventory combination number-specific display determination value graph of the result display screen 2600. Using the input device 250, the inventory deployment decision-maker selects points on the inventory combination number-specific display determination value graph for the inventory deployment to be confirmed. When detecting an input operation by the inventory deployment decision-maker, the device of the embodiment displays inventory combination numbers at the selected points on the graph. The embodiment shown in FIG. 27 illustrates an example in which the inventory deployment decision-maker selects inventory combination Nos. 846 (2710) and 648 (2720). When the inventory deployment decision-maker selects points on the inventory combination number-specific display determination value graph and then an inventory deployment display icon 2730, the multi-base inventory deployment computation device 100 of the embodiment displays an inventory deployment screen 2800 of FIG. 28.

FIG. 28 shows an example of the inventory deployment screen 2800. The inventory deployment screen 2800 displays one or more inventory deployment diagrams of the inventory combination numbers (2710 and 2720) selected by the inventory deployment decision-maker on the inventory combination number-specific display determination value graph by inputting the candidate display proposal information 2000 of FIG. 20, the display determination coefficient 1420 shown in FIG. 14, and the inventory value information 2410 of FIG. 24. The inventory deployment diagram 2800 displays the inventory values of the inventory combination numbers in the all warehouses. For a warehouse with the inventory value of 0, a dotted square 2810 may be displayed to show that there is a warehouse but the inventory value thereof is 0.

For example, in the example of inventory deployment No. 846 (2710), many product inventories are deployed in a sales company warehouse 2820 in North America. In addition, inventories are intensively deployed in a semiproduct warehouse 2830 in Asia and a parts warehouse 2840 in Europe. On the other hand, in the example of inventory deployment No. 648 (2720), many product inventories are deployed in a sales company warehouse 2850 in North America, which is the same as the example of No. 846. However, the other inventories are intensively deployed in a port warehouse 2860 in Asia.

According to FIG. 28, the inventory deployment decision-maker can confirm plural proposals in which the difference of the cash flow is 5% or less and inventories are deployed in warehouses indifferent regions. By confirming such plural proposals, the inventory deployment can be determined in consideration of potential risks (for example, exchange rate fluctuations, inflation, deterioration in security, delay of transportation means, and the like). For example, if it is determined in FIG. 28 that inflation is likely to occur in China, the inventory deployment of inventory combination No. 846 (2710) is employed. In the case where it is determined that there are concerns about environments in Russia, the inventory deployment of inventory combination No. 648 (2720) is employed to avoid the potential risks.

In the first embodiment, means for determining the inventory deployment proposal is disclosed as described above in consideration of potential risks that are serious issues in a global distribution network. Using cash flow as the evaluation index of the inventory deployment in the embodiment, the inventory deployment proposal in which the evaluation index is within an allowable range input by the inventory deployment decision-maker is searched for. In the search, information related to the display determination value is not used as restriction conditions, but possible inventory deployment proposals are evenly evaluated. specifically, the cash flow is computed for the inventory deployment proposal irrespective of the information related to the display determination value, the all inventory deployment proposals in each of which the result is within an allowable range are quantitatively evaluated and displayed using the regional information of some base that is a display proposal determination item.

As an alternative idea to consider potential risks as an object of the embodiment, it is conceivable that in the case where a region where potential risks are likely to occur is recognized in advance, the inventory deployment proposal is searched for while giving a weight so as to reduce the inventory deployment to the region. However, imposing improper restrictions on the distribution network results in concerns about reduction of the maximum value of cash flow that can be achieved. Accordingly, in the embodiment, even if a region where potential risks are likely to occur is recognized in advance, the process is performed without using the information in the search for the inventory deployment proposal, and the presence or absence of effects due to the potential risks is determined by the inventory deployment decision-maker by displaying the result.

### Second Embodiment

In the embodiment, an inventory deployment proposal in which cash flow as an evaluation index is within an allowable range input by an inventory deployment decision-maker is searched for. The all inventory deployment proposals in each of which the cash flow is within an allowable range are quantitatively evaluated and displayed using the degree of risk of some base that is a display proposal determination item.

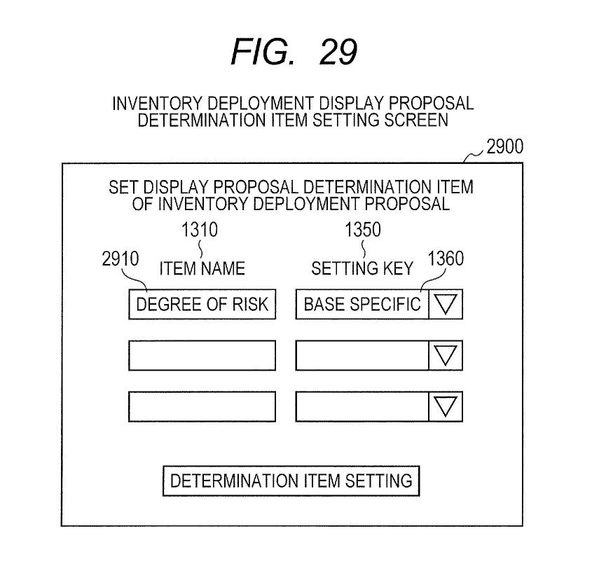

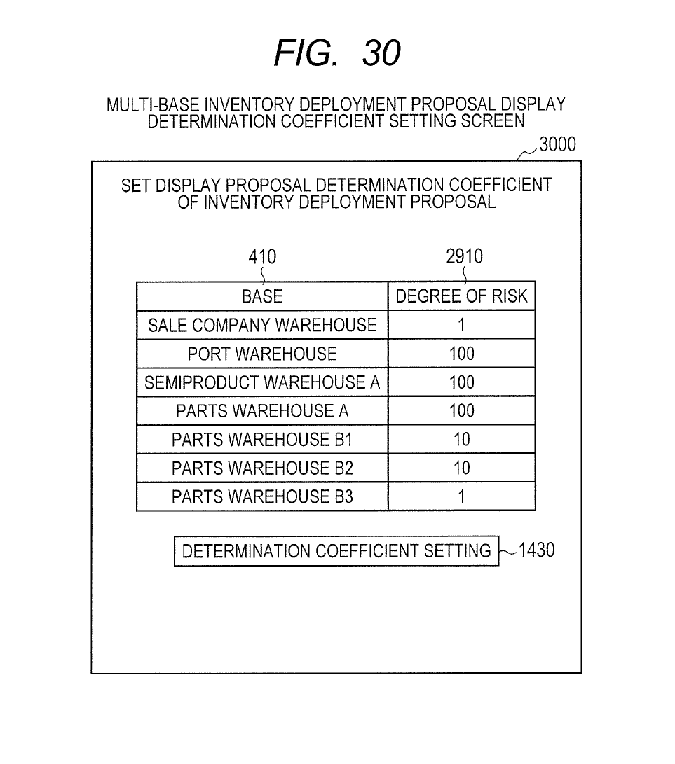

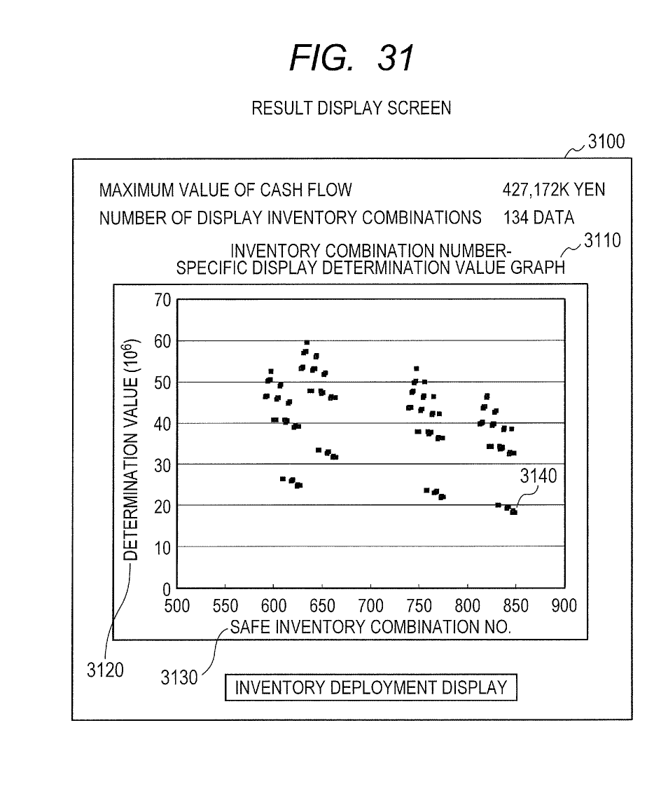

The functional configuration of a multi-base inventory deployment computation device in the embodiment is the same as that of FIG. 1, the hardware configuration example of the multi-base inventory deployment computation device is the same as that of FIG. 2, and a multi-base inventory deployment computation processing flow is the same as that of FIG. 3. However, the following point is different in the flow of FIG. 3. In (1) the external data reading 310, the item name 1310 (regional information such as North America, Asia, and Europe) of FIG. 13 is used in the first embodiment, but is changed to an item name (degree of risk) of FIG. 29 in the embodiment. As a result, the determination coefficient shown in FIG. 14 in the first embodiment is changed to that shown in FIG. 30 in the embodiment. As a result, (8) the result display 380 of FIG. 3 is changed to that of FIG. 31 instead of FIG. 26 in the first embodiment.

FIG. 29 shows an example of an inventory deployment display proposal determination item setting screen 2900 in the embodiment. As the item name 1310, the degree of risk 2910 is set, and base specific 1360 is set as a setting key 1350.

FIG. 30 shows an example of a multi-base inventory deployment proposal display determination coefficient setting screen 3000 in the embodiment. A display determination coefficient is set for each base 410. Into the degree of risk 2910 that is a display determination coefficient, the inventory deployment decision-maker inputs values such as 100, 10, and 1 on the basis of a qualitative determination in consideration of potential risk factors at a place where each base exists.

FIG. 31 shows an example of a result display screen 3100 in the embodiment. In the case of one display proposal determination item, in an inventory combination number-specific display determination value graph 3110, the horizontal axis 3130 represents the inventory period combination number 1910 and the vertical axis 3120 represents a display determination value. The display determination value is computed as determination coefficient×inventory value (2330) on the basis of the display proposal determination item-specific determination value computation processing flow of FIG. 23. Specifically, inventory deployment proposals in which a number of inventories are deployed at bases with a high degree of risk are distributed on the upper side of the vertical axis 3120. According to the drawing, it is obvious that safe inventory combination No. 850 (3140) located on the lowermost side of the vertical axis is most desirable.

As described above, using one value indicating a degree as a display determination value, the means for determining the inventory deployment proposal in consideration of potential risks is disclosed in the second embodiment. In the embodiment, the most advantageous condition can be selected without displaying because of the degree of the display determination value. However, plural proposals are displayed as shown in FIG. 31, so that it can be visibly and easily recognized whether or not there are plural second best proposals in the similar condition, or whether or not the best point differs from the second best proposal.

### Third Embodiment

In the embodiment, an inventory deployment proposal in which cash flow as an evaluation index is within an allowable range input by an inventory deployment decision-maker is searched for. The all inventory deployment proposals in each of which the cash flow is within an allowable range are quantitatively evaluated and displayed using the degree of completion of a product that is a display proposal determination item.

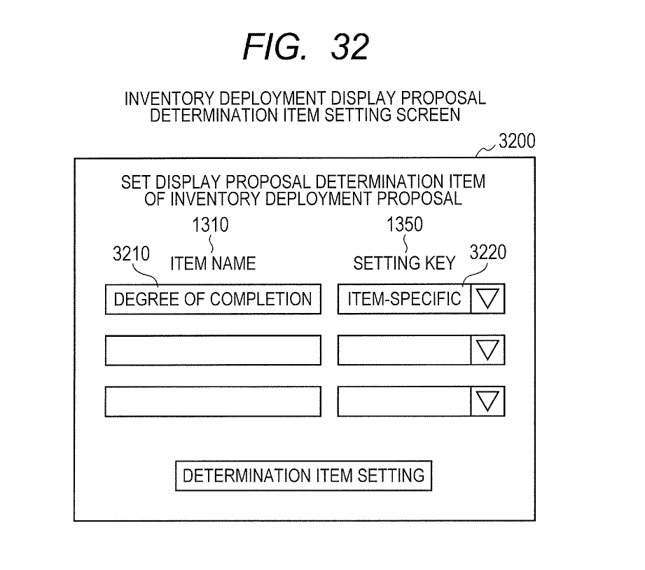

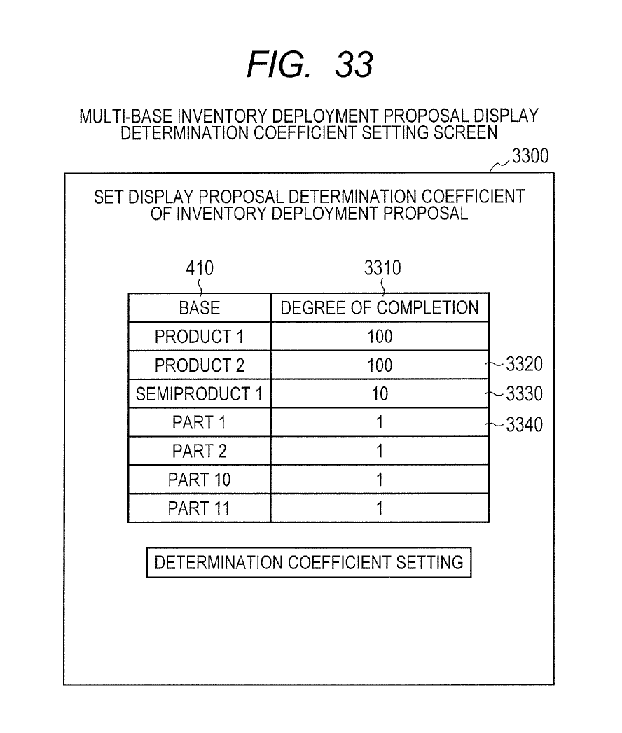

The functional configuration of a multi-base inventory deployment computation device in the embodiment is the same as that of FIG. 1, the hardware configuration example of the multi-base inventory deployment computation device is the same as that of FIG. 2, and a multi-base inventory deployment computation processing flow is the same as that of FIG. 3. However, the following point is different in the flow of FIG. 3. In (1) the external data reading 310, the item name 1310 of FIG. 13 is used in the first embodiment, but is changed to an item name (degree of completion) of FIG. 32 in the embodiment. As a result, the determination coefficient shown in FIG. 14 in the first embodiment is changed to that shown in FIG. 30 in the embodiment. As a result, (8) the result display 380 of FIG. 3 is changed to that of FIG. 33 instead of FIG. 26 in the first embodiment.

FIG. 32 shows an example of an inventory deployment display proposal determination item setting screen 3200 in the embodiment. As the item name 1310, the degree of completion 3210 is set, and base specific 3220 is set as the setting key 1350.

FIG. 33 shows an example of a multi-base inventory deployment proposal display determination coefficient setting screen 3300 in the embodiment. The display determination coefficient is set for each base 410. FIG. 33 shows a setting example in which the degree of completion 3310 that is the display determination coefficient is an example of a relative value assuming the state of completion of a product as 100 (3320), and the inventory deployment decision-maker sets a rule in which a semiproduct is represented by 10 (3330), and a part is represented by 1 (3340).

The configuration of the result display screen in the embodiment is the same as that of FIG. 31. In the case of one display proposal determination item, in the inventory combination number-specific display determination value graph, the horizontal axis 3130 represents the inventory combination number 1910 and the vertical axis 3120 represents the display determination value. The display determination value is computed as determination coefficient×inventory value (2330) on the basis of the display proposal determination item-specific determination value computation processing flow of FIG. 23. Specifically, inventory deployment proposals in which a number of inventories are deployed at bases with a high degree of completion are distributed on the upper side of the vertical axis 3120. Here, it should be noted that the degree of completion does not have information of a degree unlike the degree of risk described in the second embodiment. In the case where there are many inventories with a high degree of completion, there is no out-of-stock state as a merit even when a drastic increase in demand occurs. However, as demerits, the inventory evaluation value becomes high because the inventories are kept as expensive products, and it is difficult to divert the completed products in the case where demand for product types is changed. In the case where there are many inventories with a low degree of completion, unlike the above case, the inventory value can be made cheaper, and various product types can be handled, but it is impossible to respond to a drastic increase in demand. Thus, in the case where a drastic increase in demand is expected, the inventory deployment proposals are selected from the upper side of the vertical axis. In the case where the possibility of an increase in demand is low, the inventory deployment proposals are selected from the lower side of the vertical axis.

As described above, using one value having no degree as a display determination value, the means for determining the inventory deployment proposal in consideration of potential risks is disclosed in the third embodiment. In the embodiment, it is necessary for the inventory deployment decision-maker to select the most advantageous condition from the distribution of the displayed inventory deployment proposals because of no degree of the display determination value. Plural proposals are displayed as shown in FIG. 31, so that it can be visibly and easily recognized whether or not there are plural second best proposals in the similar condition, or whether or not the best point differs from the second best proposal.

### Fourth Embodiment

In the embodiment, an inventory deployment proposal in which cash flow as an evaluation index is within an allowable range input by an inventory deployment decision-maker is searched for. Among the inventory deployment proposals in each of which the cash flow is within an allowable range, inventory combinations with a different share in North America and a different share in Asia that is a display proposal determination item are selected and displayed by the number of displays input by the inventory deployment decision-maker.

The functional configuration of a multi-base inventory deployment computation device in the embodiment is the same as that of FIG. 1, and the hardware configuration example of the multi-base inventory deployment computation device is the same as that of FIG. 2.

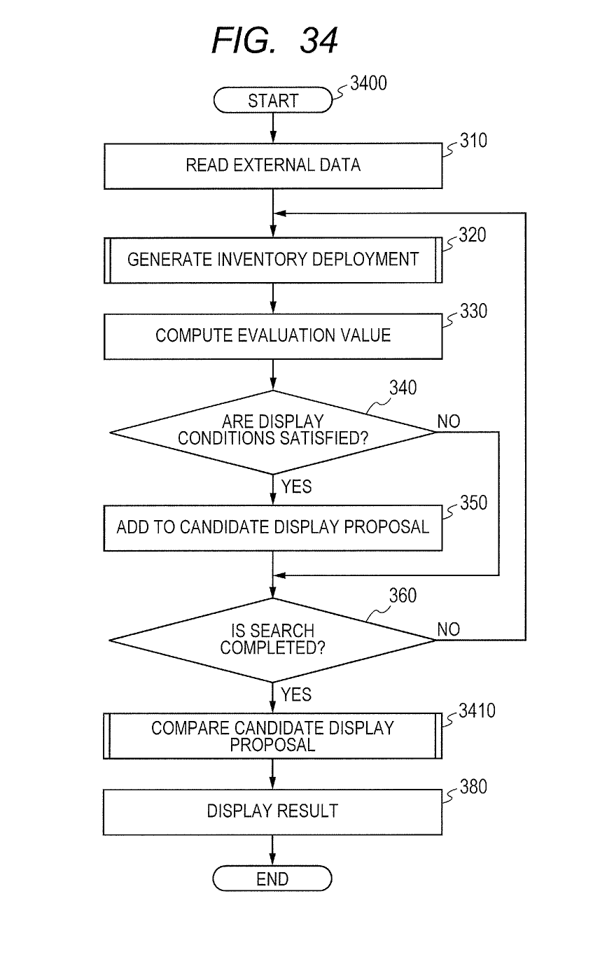

FIG. 34 shows a multi-base inventory deployment computation processing flow according to the embodiment. The entire flow is similar to that of FIG. 3 in the first embodiment. However, FIG. 34 is different from FIG. 3 in that (7) the display determination value computation 370 of FIG. 3 is changed to (7) a candidate display proposal comparison process 3410 of FIG. 34. The candidate display proposal comparison process 3410 will be described later.

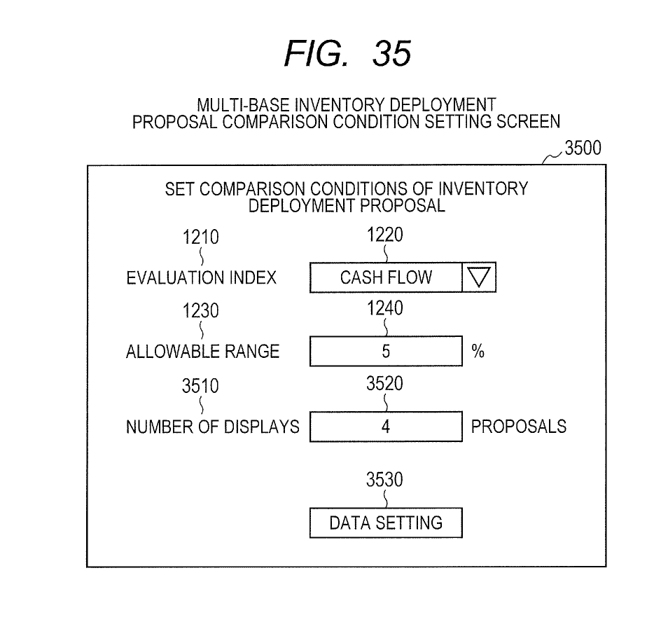

FIG. 35 shows an example of a multi-base inventory deployment proposal comparison condition setting screen 3500 in the embodiment. On the screen, the number of displays 3510 is set.

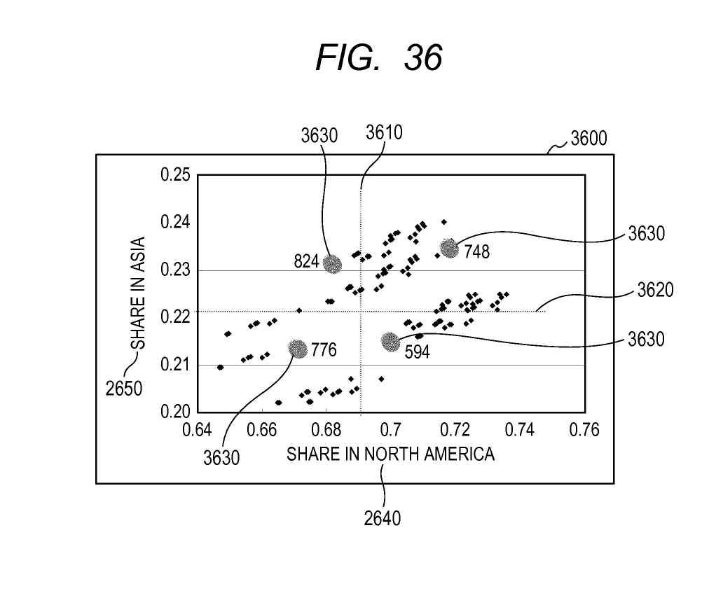

FIG. 36 shows an example of an inventory deployment screen 3600 in the embodiment. In the example of the screen, the graph is divided into the number of displays 4 (3520) set on the multi-base inventory deployment proposal comparison condition setting screen 3500 of FIG. 35 in the candidate display proposal comparison process 3410 of FIG. 34. In the embodiment, after the candidate display proposals are displayed, the region is divided at an intermediate value 3610 between the minimum value and the maximum value on the horizontal axis 2640. Further, the region is divided at an intermediate value 3620 between the minimum value and the maximum value on the vertical axis 2650 to create four regions. One representative point of the inventory combinations is selected from each of the four regions. For example, the center of gravity of each region is obtained, and a point 3630 nearest to the position of the center of gravity is selected.

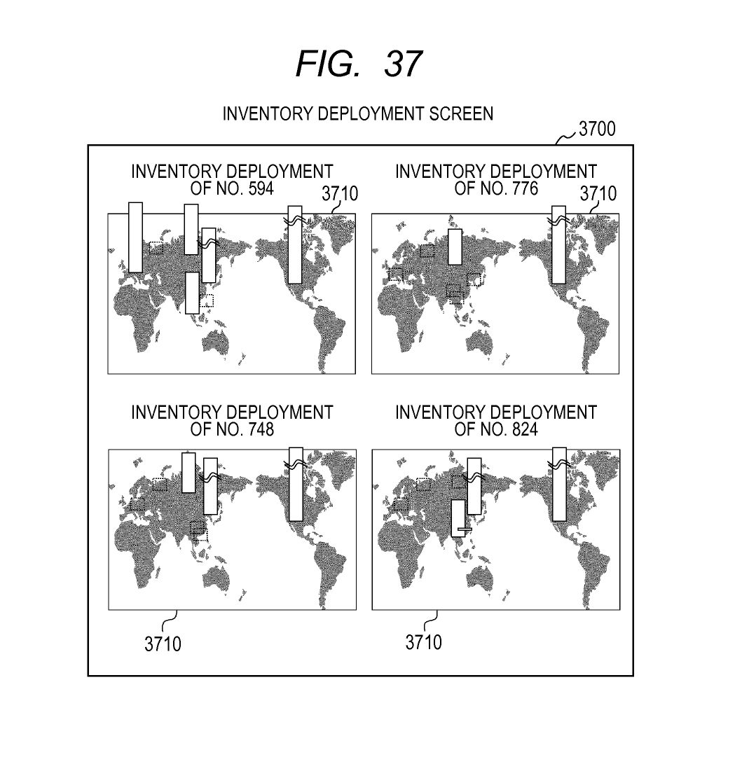

FIG. 37 shows an example of an inventory deployment screen 3700 in the embodiment. Inventory deployments 3710 corresponding to the selected four inventory combinations are displayed. By confirming the drawing, the amount of inventories deployed at each base can be confirmed in more detail than the inventory deployment screen of FIG. 36. FIG. 36 shows a screen on which candidate points are selected, and FIG. 37 shows a screen on which detailed information of the selected candidate points is analyzed.

The embodiment focuses on narrowing down the inventory deployment proposals to the number of displays input by the inventory deployment decision-maker. In the flow shown in FIG. 34, the candidate points are narrowed down using the degree of proximity to the maximum value of the cash flow. However, there is a case in which a number of inventory deployment proposals that are difficult to be confirmed by the inventory deployment decision-maker are extracted. Thus, it is necessary to further narrow down the candidate points by accepting an entry of the number that can be confirmed among those. In this case, it is desirable that the display determination values of displayed points be different from each other because various cases can be compared to each other. The method of selecting the representative points by dividing the region as described in the embodiment is an example. As another method, it is conceivable that a convex hull region is generated from the displayed regions to narrow down the display from the candidate points on the outermost circumference and the candidate points in the middle.

It should be noted that the present invention is not limited to the above-described embodiments, but various modifications may be included. For example, the embodiments have been described in detail to understandably explain the present invention, and are not necessarily limited to those having the all constitutional elements described above. Further, a part of the configuration in one embodiment can be replaced by a configuration of another embodiment, and the configuration in one embodiment can be added to another embodiment. In addition, a part of the configuration in each embodiment can be added to or replaced by another, or deleted.

Further, a part or all of the configurations, functions, processing units, processing means, and the like may be realized by hardware such as designing with an integrated circuit. Further, the configurations, functions, and the like may be realized by software while a processor interprets and executes programs for realizing the functions. Information of programs, tables, files and the like for realizing the functions can be stored in a recording device such as a memory, a hard disk or an SSD (Solid State Drive), or a recording medium such as an IC card, an SD card, or a DVD.

### REFERENCE SIGNS LIST

100 . . . multi-base inventory deployment computation device in a first embodiment, 110 . . . input unit, 120 . . . memory unit, 130 . . . multi-base inventory deployment search unit, 140 . . . multi-base inventory deployment proposal comparison unit, 150 . . . display unit, 201 . . . CPU, 210 . . . RAM, 220 . . . ROM, 230 . . . auxiliary storage device, 240 . . . display device, 250 . . . input device, 260 . . . media read device, 270 . . . communication device, 280 . . . network, 310 . . . external data read process, 320 . . . inventory deployment generation process, 330 . . . evaluation value computation process, 340 . . . display condition satisfaction determination process, 350 . . . candidate display proposal addition process, 360 . . . search completion condition determination process, 370 . . . display proposal determination value computation process, 380 . . . result display process, 400 . . . base information, 410 . . . base name, 420 . . . base classification, 500 . . . product configuration information, 510 . . . parent item name, 520 . . . child item name, 530 . . . number of configurations, 600 . . . production information, 610 . . . item name, 620 . . . supply/production LT, 700 . . . transportation information, 710 . . . destination, 720 . . . sender, 730 . . . transportation LT, 800 . . . sales price information, 810 . . . sales price, 900 . . . purchase unit price information, 910 . . . purchase unit price, 1000 . . . manufacturing cost information, 1010 . . . manufacturing unit price, 1100 . . . demand information, 1110 . . . sales date, 1120 . . . normal demand, 1130 . . . maximum demand, 1200 . . . multi-base inventory deployment proposal comparison condition setting screen, 1210 . . . evaluation index, 1220 . . . allowable range of evaluation value, 1250 . . . data setting icon, 1300 . . . multi-base inventory deployment proposal determination item setting screen, 1310 . . . display proposal determination item name, 1320 . . . display proposal determination item key, 1330 . . . determination item setting icon, 1400 . . . multi-base inventory deployment proposal display determination coefficient setting screen, 1410 . . . display proposal determination item, 1420 . . . display determination coefficient, 1430 . . . determination coefficient setting icon, 1700 . . . product-specific inventory period information, 1710 . . . product name, 1720 . . . base name where product is sold, 1730 . . . warehouse name, 1740 . . . minimum period, 1750 . . . maximum period, 1800 . . . product-specific inventory period combination information, 1810 . . . product-specific inventory period combination No., 1820 . . . inventory period (week), 1900 . . . inventory period combination information, 1910 . . . inventory period combination No., 2000 . . . candidate display proposal information, 2010 . . . evaluation value, 2020 . . . ratio to maximum value of evaluation value, 2100 . . . inventory value information, 2110 . . . inventory value, 2500 . . . determination value computation result, 2600 . . . result display screen, 2610 . . . maximum value of cash flow, 2620 . . . inventory combination number-specific display determination value graph, 2630 . . . number of display inventory combinations, 2800 . . . inventory deployment drawing, 2900 . . . inventory deployment display proposal determination item setting screen, 3000 . . . multi-base inventory deployment proposal display determination coefficient setting screen, 3100 . . . result display screen, 3200 . . . inventory deployment display proposal determination item setting screen, 3300 . . . multi-base inventory deployment proposal display determination coefficient setting screen, 3500 . . . multi-base inventory deployment proposal comparison condition setting screen, 3700 . . . inventory deployment screen

1. A multi-base inventory deployment computation device that searches for all multi-base inventory deployment proposals in each of which the value of an evaluation index is within an allowable range relative to the best value in each base on a distribution network to present results in accordance with display proposal determination items, the device comprising:
a memory unit that stores: evaluation condition information including the evaluation index and the allowable range; display proposal determination item information used to quantitatively evaluate the difference between inventory deployment proposals in each of which the value of the evaluation index is within the allowable range; display determination coefficient information defining a coefficient for each display proposal determination item; demand information including sales plans of products; product configuration information representing configurations of items configuring the products; transportation information including information of transportation routes between the bases and transportation lead times; production information including lead times of the bases where each item is supplied and produced; parts purchase unit price information; manufacturing cost information including the cost incurring in manufacturing; and sales price information including the sales prices of the products;
a multi-base inventory deployment search unit that obtains a maximum period by adding the total lead time from the time each item is shipped from a warehouse to the time the item arrives at a base where the product is sold to a minimum period and by adding the total lead time until all child products configuring the item arrive at the warehouse to a minimum period for each product included in the demand information, for each item configuring the product, and each warehouse base to compute product-specific inventory period combination information at each warehouse base, and combines the pieces of product-specific inventory period combination information to each other according to each product type to create inventory period combination information;
a multi-base inventory deployment proposal comparison unit that computes the value of the evaluation index of the evaluation condition information by performing an inventory management computation for the created inventory period combination information, compares the value with the maximum value of the evaluation index to determine an inventory period combination having the value of the evaluation index satisfying the allowable range as a candidate display proposal, and computes a display determination value by multiplying a display determination coefficient by an inventory value according to each display proposal determination item for the candidate display proposal; and
a display unit that displays plural inventory period combinations selected by the multi-base inventory deployment proposal comparison unit.

2. The multi-base inventory deployment computation device according to claim 1, wherein the multi-base inventory deployment search unit computes the lead time required to deliver each item configuring the product from each warehouse to a sales base as the product using the transportation information and the product configuration information for each product included in the demand information to be determined as the minimum value of an inventory period, computes the sum of the lead time from each warehouse to the sales base and the maximum lead time from each warehouse to a parts vendor of each part configuring the item to be determined as the maximum value of the inventory period, then obtains all combinations of product-specific inventory periods each of which is a predetermined unit period allocated to each warehouse on routes of the distribution network for each product, each of which falls between the minimum period and the maximum period, and in which the total of the inventory periods allocated to the respective warehouses corresponds to the maximum period of the corresponding routes of the distribution network, and combines the pieces of product-specific inventory period combination information to each other according to each product type to create the inventory period combination information.

3. The multi-base inventory deployment computation device according to claim 1, wherein the display unit displays the maximum value of the evaluation index, the number of inventory period combinations having the value of the evaluation index satisfying the allowable range, and a graph obtained by plotting the inventory period combinations having the value of the evaluation index satisfying the allowable range on coordinate axes in which the horizontal axis and the vertical axis represent different display proposal determination items.

4. The multi-base inventory deployment computation device according to claim 3, wherein, on the graph displayed on the display unit and obtained by plotting the inventory period combinations having the value of the evaluation index satisfying the allowable range, information of points of inventory deployment selected using an input device to be confirmed by an inventory deployment decision-maker is accepted, and the inventory values of the all warehouses included in the inventory period combination information of the selected points are displayed at the locations of the warehouses on a map.

5. The multi-base inventory deployment computation device according to claim 1, wherein the display unit displays a setting screen for inputting the display proposal determination item information to accept a display proposal determination item representing the share of inventory values in a specific region, the degree of risk of each base, or the degree of completion of each product, and information of a key of each display proposal determination item selected and input by the inventory deployment decision-maker, and the accepted display proposal determination item information is stored in the memory unit.

6. The multi-base inventory deployment computation device according to claim 1, wherein the display unit displays the maximum value of the evaluation index, the number of inventory period combinations having the value of the evaluation index satisfying the allowable range, and a graph obtained by plotting the inventory period combinations having the value of the evaluation index satisfying the allowable range on coordinate axes in which the horizontal axis represents an inventory period combination number and the vertical axis represents the determination value of the display proposal determination item.

7. The multi-base inventory deployment computation device according to claim 1, wherein the display unit displays a setting screen for inputting the display determination coefficient information to accept information of the display determination coefficient for each display proposal determination item set and input by the inventory deployment decision-maker on a key basis of the display proposal determination item, and the accepted display determination coefficient information is stored in the memory unit.
